(19) United States
(12) Patent Application Publication
(10) Pub. No.: US 2004/0003692 A1
(43) Pub. Date: Jan. 8, 2004

(54) Bow-making machine

(76) Inventors: Thomas Kent Wilhelm, Dallas, PA (US); Bernard Paul Andreoli, Old Forge, PA (US); John Edward Drake, New Milford, PA (US)

Correspondence Address: DUANE MORRIS LLP, 100 COLLEGE ROAD WEST, SUITE 100, PRINCETON, NJ, 08540-6604, US

(21) Appl. No.: 10/226,814

(22) Filed: Aug. 23, 2002

Related U.S. Application Data
(60) Provisional application No. 60/393,709, filed on Jul. 3, 2002.

(51) Int. Cl. B26D 1/00

(52) U.S. Cl. 83/13

(57) ABSTRACT

A machine for fabricating ornamental bows feeds slit sheet material from a roll, and cuts trapezoidal or truncated-triangle portions from the roll. The cut sheets are translated by a rotatable transfer head to a roll-up station, where a folding apparatus or harp receives the sheets. The folding harp has smaller dimensions than the separated sheets, so there is an overlap. The harp folds, to juxtapose border portions of the sheets. A hold-down bar presses the protruding borders onto a row of needles on the upper surface of a roll-up bar. An element guard bar is lowered, to press loops of the bow onto a front surface of the roll-up bar. A collet is introduced and grasps the sheets, and is raised and rotated to roll up one edge of the sheets against the upper surface of the roll-up bar. When rolling is finished, fingers grasp the hub of the bow, and the collet is retracted. The fingers carry the bow to a glue operation for finishing.

### FIELD OF THE INVENTION

This invention relates to automated bow-making machines, and more particularly to such machines which fabricate ornamental objects such as bows.

### BACKGROUND OF THE INVENTION

U.S. Pat. No. 5,609,928, issued Mar. 11, 1997 in the name of Yedlin et al. describes a decorative bow or ornamental object, and a method for making the bow. As therein described, the bow is made by defining a truncated-triangular or trapezoidal sheet of thin material, which contains a plurality of generally parallel slits or cuts extending between upper and lower borders of the truncated-triangular or trapezoidal sheet to thereby define a plurality of generally parallel strips extending between the borders. The method involves folding the sheet on itself with the borders abutting, so that the thin strips are formed into loops. The conjoined borders of the folded sheet are then wound on a rigid core to generate a plurality of interlaced or co-located loops of different sizes, defining a generally rounded shape.

In the past, these bows have been made by hand, by methods including application of a strip of adhesive to the conjoined borders to hold them together following the folding step.

Automated methods for manufacture of ornamental bows are desired.

### SUMMARY OF THE INVENTION

A web cutting apparatus according to an aspect of the invention is for cutting individual trapezoidal sheets from an end of the web includes a movable carriage movable in a fore-aft direction, and a generally horizontal rotatable bed mounted on the movable carriage. The rotatable bed is rotatable about a vertical axis on the movable carriage. A web cutter is affixed to the rotatable bed. The cutter cuts along a cutting path making a fixed angle across the rotatable bed. A positioning surface affixed to the rotatable bed extends parallel with the cutting path. A trapezoidal transfer head defines first and second non-parallel sides. The transfer head is rotatable about a vertical axis, and movable in the fore-aft direction. A brake is connected to the carriage, for tending to resist, but not totally prevent, motion in the fore-aft direction. A control arrangement is coupled to the transfer head and to the web cutter, for sequentially (a) moving the transfer head in the aft direction with a first orientation, such as to bring a first of the non-parallel sides into contact with the positioning surface, whereby the positioning surface rotates into parallelism with the first of the non-parallel sides, (b) moving the transfer head in the aft direction against the force of the brake after the positioning surface is parallel with the first non-parallel side of the transfer head, to thereby move the rotatable bed in the aft direction, (c) locking the transfer head to the rotatable bed and to the web, (d) moving the transfer head in the fore direction, carrying the rotatable bed and the web therewith, (e) when the transfer head and rotatable bed have moved in the fore direction by a dimension of one of the trapezoidal sheets, stopping the motion in the fore direction, (f) actuating the web cutter to thereby cut that portion of the web lying under the transfer head from the remaining portion of the web and define a separated trapezoidal sheet, and (g) releasing the transfer head from the rotatable bed, while continuing to lock the transfer head to the separated trapezoidal sheet.

In a particular version of this web cutting apparatus, the control arrangement is further for moving the transfer head with the separated trapezoidal sheet to a target location, and depositing the separated trapezoidal sheet at the target location. In this particular version, the control arrangement is further for (a) rotating the transfer head around the vertical axis, and moving the transfer head in the aft direction with a second orientation such as to bring a second of the non-parallel sides into contact with the positioning surface, whereby the positioning surface rotates into parallelism with the second of the non-parallel sides, (b) moving the transfer head in the aft direction against the force of the brake after the positioning surface is parallel with the second non-parallel side of the transfer head, to thereby move the rotatable bed in the aft direction, (c) locking the transfer head to the rotatable bed and to the web, (d) moving the transfer head in the fore direction, carrying the rotatable bed and the web therewith, (e) when the transfer head and rotatable bed have moved in the fore direction by a dimension of one of the trapezoidal sheets, stopping the motion in the fore direction, (f) actuating the web cutter to thereby cut that portion of the web lying under the transfer head from the remaining portion of the web and define a second separated trapezoidal sheet, and (g) releasing the transfer head from the rotatable bed, while continuing to lock the transfer head to the second separated trapezoidal sheet. Following this sequence of steps, the control arrangement is further for moving the transfer head with the second separated trapezoidal sheet to the target location, and depositing the separated trapezoidal sheet at the target location. In this version, the control arrangement is further for rotating the transfer head about the vertical axis in conjunction with moving the transfer head with the first separated trapezoidal sheet to the target location.

A particular variant of the web cutting apparatus further including a controllable web brake for controllably braking the web In this particular variant, the control arrangement is further for setting the web brake at all times except that time beginning at which the transfer head begins to move in the fore direction locked to the web and ending at the time of cutting.

Another avatar of the web cutting apparatus further comprises a web loop control for tending to maintain a minimum length of hanging loop of web for reducing frictional forces on the web during that time during which the web moves in the fore direction locked to the transfer head.

According to another aspect of the invention, a web cutting and sheet transfer apparatus comprises advancing arrangement for advancing the web material onto a cutting bed, a cutting arrangement for sequentially cutting individual trapezoidal sheets from an end of the web, where the cutting arrangement comprising a cutting element mounted below the cutting bed for controllably cutting along a path associated with the cutting head. A cutting bed rotating arrangement is coupled to the cutting head, for rotating the cutting bed by a selected amount between cuts, so that cuts at various angles across the web material sequentially create individual trapezoidal sheets, alternately oppositely oriented on the cutting bed. A transfer arrangement is associated with the cutting arrangement. the transfer arrangement includes a transfer head having the same general shape as the individual trapezoidal sheets and also includes an arrangement for controllably attaching the individual trapezoidal sheets to the transfer head, at least along a border of the individual trapezoidal sheets, for sequentially picking up the individual trapezoidal sheets, and transferring the individual trapezoidal sheets to a location remote from the cutting bed. A transfer rotation arrangement is coupled to the transfer arrangement, for rotating the transfer head so that the individual trapezoidal sheets sequentially transferred to the remote location are placed at the remote location in the same orientation.

According to another aspect of the invention, an apparatus is for rolling ornamental objects from individual sheets of trapezoidal material defining plural border regions. The apparatus comprises a fixed roll-up bar defining a flat, straight upper surface, and a movable folding bar defining a generally straight, flat surface. The movable folding bar is rotatable around an axis from a first position to a second position, so as to bring an edge of the movable folding bar into juxtaposition with an edge of the flat, straight surface of the roll-up bar, and so that the movable folding bar does not cover the flat, straight surface of the roll-up bar. The movable folding bar further includes a controllable affixation arrangement adapted for holding at least a portion of one of the border regions of an individual trapezoidal sheet of workpiece material against the movable folding bar. In one version of this aspect of the invention, the controllable affixation arrangement includes apertures on the movable folding bar to which vacuum is controllably applied. A folding arrangement is coupled to the movable folding bar, for rotating the movable folding bar into juxtaposition with the edge of the flat, straight surface of the roll-up bar, as a result of which, or whereby, at least a portion of one of the border regions of the individual trapezoidal sheet is juxtaposed with at least a portion of an other one of the border regions of the individual trapezoidal sheet. A temporary affixation arrangement is associated with the roll-up bar, for at least temporarily holding together the juxtaposed border regions of the individual trapezoidal sheet. In one version of this aspect of the invention, the temporary affixation arrangement includes a plurality of pins projecting above the flat, straight surface of the roll-up bar. A grasping collet is provided for grasping the juxtaposed border regions of the individual trapezoidal sheet. The collet is controllably rotatable and translatable from a starting position. A movable trapezoidal sheet hold-down bar is movable with respect to the flat, straight surface of the roll-up bar. The trapezoidal sheet hold-down bar includes a straight surface for, when the straight surface of the trapezoidal sheet hold-down bar is juxtaposed with the flat, straight surface of the roll-up bar, tending to hold the juxtaposed border regions of the individual trapezoidal sheet in communication with the affixation arrangement. A control arrangement is provided for, when a single trapezoidal sheet is placed on the movable folding bar in the first position thereof, performing the steps of (a) causing the folding arrangement to operate to thereby fold the trapezoidal sheet to form a folded trapezoidal sheet, (b) causing the movable trapezoidal sheet hold-down bar to move relative to the flat, straight surface of the roll-up bar to become juxtaposed therewith, for tending to hold the juxtaposed border regions of the individual trapezoidal sheet in communication with the affixation arrangement, (c) causing the collet to grasp the juxtaposed border regions of the individual trapezoidal sheet, (d) causing the collet to rotate in conjunction with translation of at least the collet along a path generally parallel with the flat, straight surface of the roll-up bar, whereby at least the juxtaposed border portions of the individual trapezoidal sheet are wound on the collet to define a hub, (e) stopping the rotation of the collet and the translation, (f) grasping the hub with a transfer apparatus while removing the collet from the hub, and (g) moving the trapezoidal sheet hold-down bar from the juxtaposition, translating the collet to its starting position, and causing the movable folding bar to move to the first position.

In a particular avatar of this aspect of the invention, the affixation arrangement comprises a plurality of pins extending orthogonally from the flat, straight surface of the roll-up bar, and the flat, straight surface of the trapezoidal sheet hold-down bar defines an elongated groove dimensioned to clear the pins when the flat, straight surface of the trapezoidal sheet hold-down bar is juxtaposed with the flat, straight surface of the roll-up bar.

In another avatar of this aspect of the invention, the starting position of the collet lies in a cutout in the flat, straight upper surface of the roll-up bar, and the control arrangement causes the collet to translate to a location above the cutout before the step of causing the collet to rotate in conjunction with translation of at least the collet along a path generally parallel with the flat, straight surface of the roll-up bar.

In yet another avatar of this aspect of the invention, the controllable affixation arrangement associated with the movable folding bar comprises a plurality of controlled-vacuum apertures adapted for holding at least a portion of one of the border regions of an individual trapezoidal sheet, and the control arrangement, after the step of causing the movable trapezoidal sheet hold-down bar to move relative to the flat, straight surface of the roll-up bar to become juxtaposed therewith, performs the additional step of turning off the vacuum in the controlled-vacuum apertures.

In a further avatar of this aspect of the invention, the control arrangement, in conjunction with the step of causing the translation of at least the collet along a path generally parallel with the flat, straight surface of the roll-up bar, further causes the translation of the trapezoidal sheet hold-down bar generally in consonance with the translation of the collet.

In a further avatar of this aspect of the invention, the fixed roll-up bar defining a flat, straight upper surface further defines a front surface generally orthogonal to the flat, straight upper surface, and the apparatus further comprises an element guard hinged along an axis generally orthogonal to the front surface, and movable from a disengaged position to an engaged position lying adjacent to the front surface. In this further avatar, the control arrangement further performs the step, prior to the step of causing the collet to rotate in conjunction with translation, of moving the element guard to the engaged position.

According to a yet further avatar of this aspect of the invention, the apparatus further comprising an element guard, and the control arrangement, in conjunction with the step of causing translation of at least the collet along a path generally parallel with the flat, straight surface of the roll-up bar, further causes the translation of the element guard generally in consonance with the translation of the collet.

According to another aspect of the invention, a method for making a bow from individual trapezoidal sheets of material by means of a machine, starts with sheets of material which define at least generally parallel slits extending between border regions to thereby define generally parallel strips. The method according to this other aspect of the invention comprises the step of applying each trapezoidal sheet to a folding apparatus including at least a portion of a roll-up surface of a fixed rollup element and a movable folding element which, when folded, is juxtaposed with an edge of the roll-up surface, but which does not fully extend thereover. The applying of each trapezoidal sheet is performed in such a manner that a border portion of the trapezoidal sheet extends beyond the folding element, whereby, when the folding portion of the folding apparatus is folded toward the roll-up element, at least a border region of the folded trapezoidal sheet is exposed above the roll-up surface. The movable element of the folding apparatus is folded or moved to a folded position, thereby bringing the borders of the trapezoidal sheet into juxtaposition over the roll-up surface of the roll-up element, and forming the strips into loops. A hold-down bar is moved toward the roll-up surface of the roll-up element, to thereby press together the juxtaposed border regions of the folded trapezoidal sheet. An element guard is translated in a first direction generally parallel with a front surface of the roll-up element, to a position in which portions of the loops of the trapezoidal sheet remote from the hold-down bar extend generally parallel with the front surface of the roll-up element. The juxtaposed border regions of the folded sheet are grasped with a rotatable collet at a location near a first end of the folded trapezoidal sheet. The collet is simultaneously rotated and translated toward a second end, opposite to the first end, of the trapezoid sheet. The hold-down bar and element guard are also translated toward the second end of the trapezoidal sheet to thereby form the ornamental bow. The ornamental bow has a hub wound about the collet. The element guard is translated in a second direction, opposite to the first direction. The hub of the ornamental bow is grasped with at least one transfer element, and the grasp of the collet on the sheet material of the ornamental bow is released. The collet is withdrawn from the hub region. The ornamental bow is translated, by means of the transfer element, to a finishing station for at least fastening the hub.

In a particular avatar of this method according to an aspect of the invention, between the steps of applying each trapezoidal sheet to a folding apparatus and folding the movable portion of the folding apparatus to the folded position, vacuum is applied to at least some apertures adjacent border portions of the folding portion and the fixed portion of the folding apparatus, to thereby aid in holding the trapezoidal sheet to the folding apparatus.

In another avatar of this method according to an aspect of the invention, the step of moving a hold-down bar includes the step of pressing the juxtaposed border regions onto a plurality of pins affixed to the roll-up surface.

In another avatar of this method according to an aspect of the invention, prior to the step of rotating the collet and translating the collet, hold-down bar, and element guard, the step is performed of raising the collet, without raising the hold-down bar and the element guard.

In another avatar of this method according to an aspect of the invention, in conjunction with the step of simultaneously rotating the collet and translating the collet, hold-down bar, and element guard, of raising the collet monotonically as a function of position of the collet relative to the roll-up bar.

### BRIEF DESCRIPTION OF THE DRAWING

FIG. 1 is a plan view of a portion of a web which is slit in trapezoidal regions with mutually parallel slits;

FIG. 2a is a simplified elevation view of a roll feed arrangement in conjunction with the arrangement of FIG. 1, and FIG. 2b is a detail thereof;

FIG. 3a is a simplified partially exploded, perspective or isometric view of a web transfer head, feed and cutter arrangement according to an aspect of the invention, also illustrating a separate trapezoidal sheet of workpiece material, FIG. 3b is a simplified perspective or isometric view of the bottom of the transfer head of FIG. 3a, and FIG. 3c is a detail of a portion thereof;

FIGS. 4a, 4b, 4c, 4e and 4g are simplified plan views of a portion of the arrangement of FIG. 3a at various times related to the operation of the apparatus, and FIGS. 4d and 4f are simplified cross-sectional elevation views of portions of the arrangements of FIGS. 4c and 4e, respectively;

FIGS. 5a, 5b, 5c, 5d, 5e, 5f, 5g, 5h, and 5i are simplified plan views of the advancing web, transfer head position, and target or harp position during various portions of the cycling according to an aspect of the invention;

FIG. 6a is a simplified perspective or isometric view of a roll-up apparatus according to an aspect of the invention, and FIG. 6b is a simplified side elevation view of a portion of the arrangement of FIG. 6a, to illustrate the gap between the collet and the roll-up bar;

FIGS. 7a, 7c, 7d, 7e, 7f, 7g, and 7h are simplified cross-sectional views including the roll-up bar of FIGS. 6a and 6b under various conditions which occur during operation of the apparatus according to an aspect of the invention, and FIG. 7b is a similar cross-sectional view illustrating a problem which can occur under some conditions;

FIGS. 8a, and 8b are simplified perspective or isometric views of the upper and lower sides of a hold-down bar according to an aspect of the invention, and FIG. 8c illustrates details of bar of FIG. 8b;

FIG. 9a is a simplified, partially exploded, perspective or isometric view of a collet and collet drive arrangement which may be used, according to an aspect of the invention, in the apparatus of FIGS. 6a and 6b, FIG. 9b illustrates a rear portion of an element of FIG. 9a, FIG. 9c is an axial or end view of the collet of FIG. 9a, FIG. 9d shows the effects on the diameter of the collet of grasping and releasing the collet, and FIG. 9e is a simplified view of the other end of the collet and collet drive arrangement of FIG. 9a;

FIG. 10 is a simplified frontal view of a portion of the apparatus of FIGS. 6a and 6b related to the operating state described in conjunction with FIG. 7h, showing how bow transfer fingers grasp the hub of the finished bow;

FIG. 11 is a plot illustrating programmed velocity of the translating collet, hold-down arm, and element guard; and

FIG. 12 is a simplified perspective or isometric view of a portion of the apparatus of FIGS. 6a and 6b after roll-up, and before the element guard is raised, showing air flow apertures andor jets.

### DESCRIPTION OF THE INVENTION

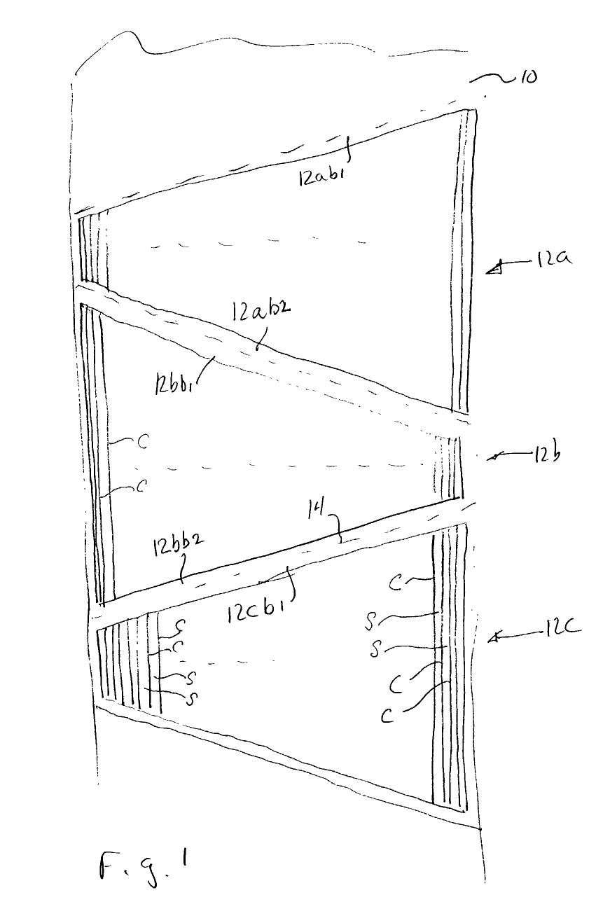

In a particular embodiment of an automated machine for fabrication of bows or similar ornamental objects, the web, film, or sheet of material 10 of FIG. 1 is received on rolls, with trapezoidally-disposed sets of mutually-parallel slits or cuts defined therein, parallel to the edges of the web material 10, with a border region separating the ends of the slits. The web material is supported by a layer of dunnage. In FIG. 1, the trapezoidally slit sections or portions of the web 10 are designated 12a, 12b, and 12c. Each trapezoidally slit section, such as section 12b, contains a pair of border regions 12bb1 and 12bb2. As illustrated, border region or section 12bb2 of section 12b is conceptually separated from a corresponding border section 12cb1 of section 12c by a dash line 14. Thus, each trapezoidal section “points” in a direction opposite to that of its immediately adjacent mates. The alternately left- and right-oriented trapezoids form a continuous web approximately 12 inches wide, and arrives with a support or dunnage layer or film which is slightly wider than the trapezoid-bearing film 10.

According to an aspect of the invention, a diagonal cut is machine-made along the separation lines 14 of FIG. 1. The diagonal cut is made to thereby separate one of the trapezoidal, slitted sheet portions, such as 12, 12b, or 12c, from the remainder of sheet material or web 10, so that further processing can be performed on that portion.

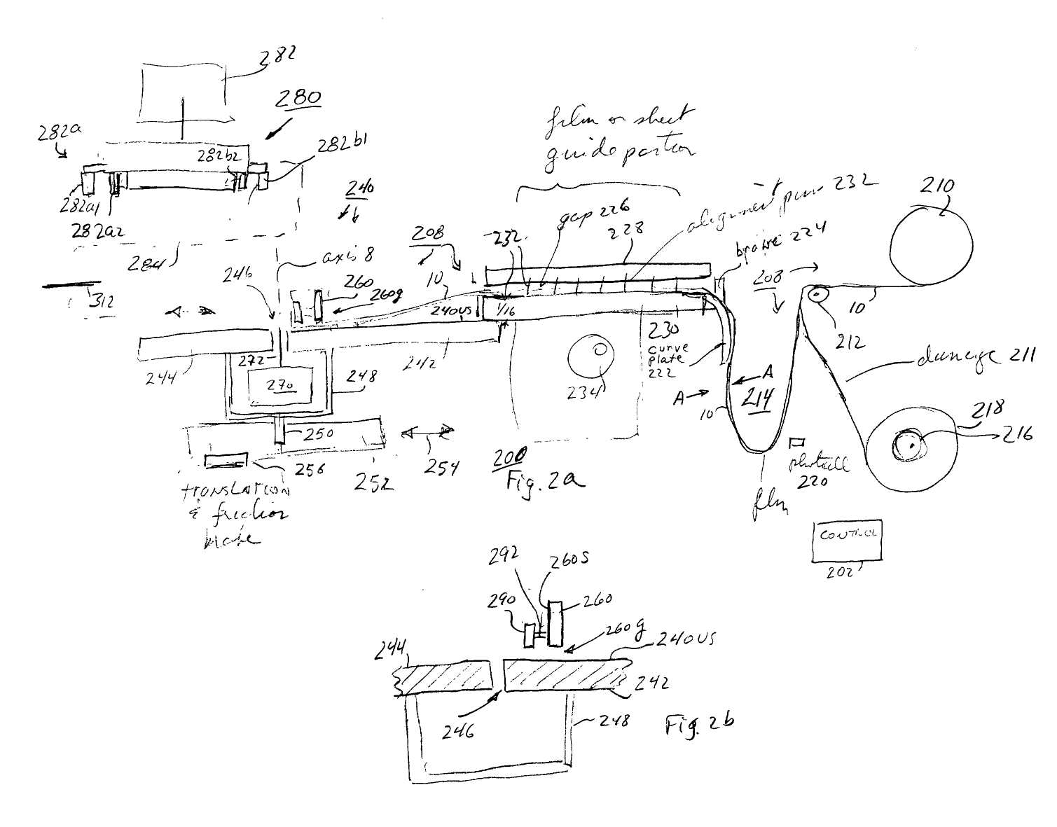

In FIG. 2a, the roll 210 of sheet or web material 10 unwinds the web 10 and dunnage sheet 211 over an idler roller 212 of a web cutting and translation apparatus designated generally as 200. The idler roller 212 leads the web into a tension releasing loop 214 whenever a motor 216 associated with a dunnage pick-up roll 218 rotates the pick-up roll 218 to draw the dunnage 211 over idler roller 212. The web path as a whole is designated as 208. Motor 216 is controlled by a sensor 220 which senses the position of the lower end of the loop 214, and commands rotation of motor 218 in response to a short loop. Just before contacting a curve plate 222, high-pressure air (A) is directed at the web from both sides, to tend to assure that the cuts or slits C of each trapezoidal section of the web (FIG. 1) are fully separated. From loop 214, the sheet material 10 extends over curve plate 222 and past a controllable brake 224, to enter a gap 226 lying between upper and lower sandwich plates 228 and 230. The width of the web path extending between sandwich plates 228 and 230 is defined by a plurality of elongated pins, some of which are designated 232. These alignment pins are in two rows, each of which rows lies parallel with the web path through the gap 226, to define the edges of the web path. The pins touch the web along at least a portion of the length of the guide to provide guidance. The separation between the two rows of pins is made adjustable by means of a crank 234.

The web 10 extending through the gap 226 exits at the left end (in FIG. 2a) of the sandwich plates 228, 230, and extends over a rotatable and translatable bed designated generally as 240, which includes a generally triangular- or sector-shaped portion 242 and a rounded portion 244. Portions 242 and 244 of bed 240 are separated by a knife gap 246 lying therebetween, but the two portions 242 and 244 are firmly affixed to each other by means of a channel structural element 248 lying beneath the bed 240. A vertically-disposed axle 250 allows the bed 240 to rotate about an axis 8 relative to a translatable base 252. Translatable base 252,in turn, is movable in the directions indicated by arrows 254. A friction brake illustrated as 256 prevents unwanted motion of the base 252.

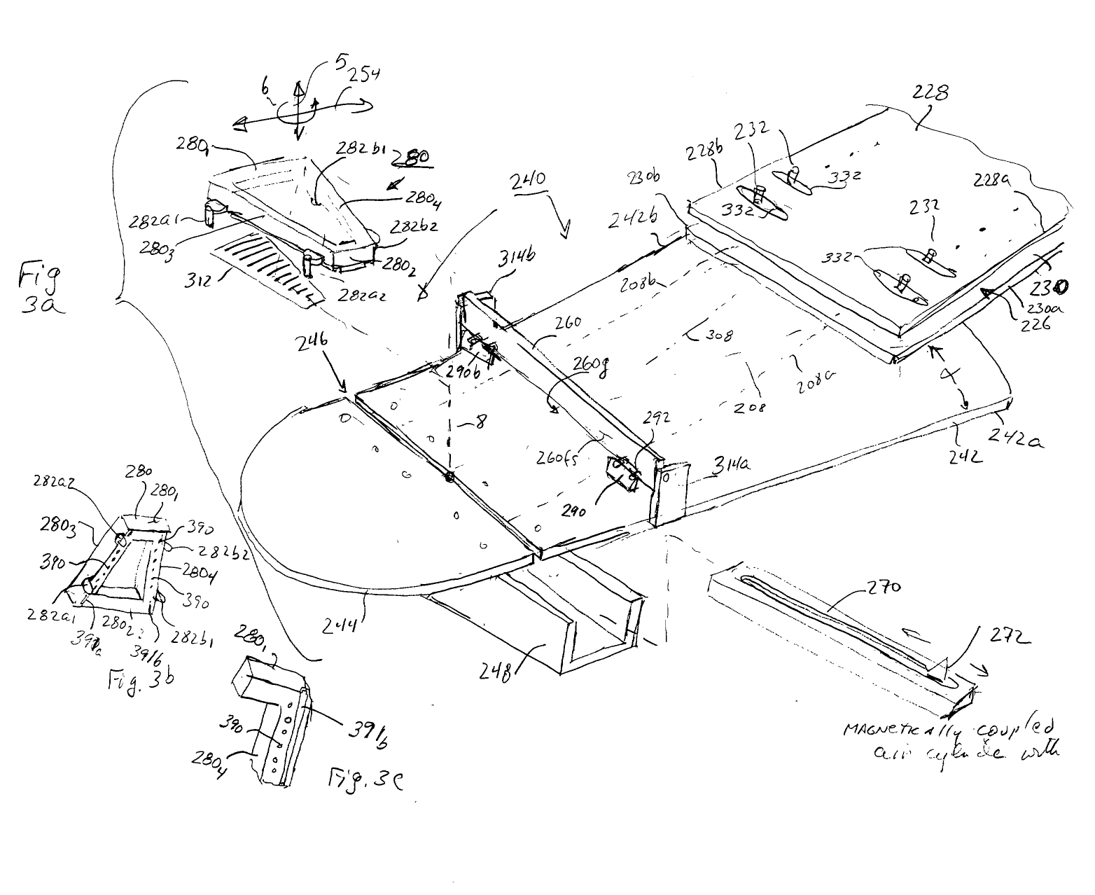

In FIG. 2a, a positioning bar 260 is affixed to bed 240 adjacent knife gap 246, and lies parallel therewith. The mounting of positioning bar 260 is such as to leave a gap 260g between the positioning bar 260 and the upper surface 240us of bed 240, sufficient to allow the web 10 to pass therethrough. The positioning bar 260 provides a front surface 260fs against which the positioning pins of one of sets 282a or 282b can bear, to rotate the bed 240 to the appropriate position for cutting of the next following trapezoidal sheet 312 from the web 10. The positioning pins 282a1, 282a2 can be considered to together define two points along a first nonparallel “side” 280₃ (FIG. 3a) of the transfer head 280, and positioning pins 282b2 and 282b2 together define the other nonparallel side 280₄ of the transfer head.

Also in FIG. 2a, a commercially available air cylinder with magnetic coupling, illustrated in end view as 270, extends within the channel 248 directly under the knife gap 246. A knife blade 272, which in one embodiment of the invention is a simple killing arrowhead, extends through the gap, and is magnetically coupled to the air-cylinder-movable portion (not illustrated) of the air cylinder/magnetic coupling 270, for controllable motion along the gap.

A translating and rotating transfer head 280 in FIG. 2a is supported by means illustrated as 282, which includes an air cylinder and translation apparatus. Transfer head 280 is trapezoidal in plan view, and bears two positioning pin sets 282a, 282b, each including two positioning pins. In FIG. 2a, the positioning pins of set 282a are designated 282a1 and 282a2, and the positioning pins of set 282b are designated 282b1 and 282b2. As indicated by dash line 284, transfer head 280 actually lies just above the upper surface 240us of the bed 240 during a portion of its translation.

FIG. 2b illustrates details of the positioning bar 260. In FIG. 2b, an additional locking bar 290 is positioned before front surface 260s of positioning bar 260, and is supported there by means of a pin 292 and another pin (not visible).

FIG. 3a illustrates a portion of the arrangement of FIG. 2a. In FIG. 3a, the slots 332 extending through upper sandwich plate 228 accommodate the excursion range which pins 232 make in the various positions which the pins can take for defining various possible widths of the web path 208. As illustrated in FIG. 3a, bed portion 242 of movable bed 240 is in a “clockwise” rotational position about axis 8, so that the longitudinal axis 308 of web path 208 is in a relatively offset position. To put it another way, the position of bed 240 of FIG. 3a is such that an angle α is made between side 242a of bed portion 242 and the sides of sandwich plates 228 and 230, which is greater than the corresponding 0° (parallel lines) angle between side 242b and the sides of sandwich plates 228 and 230. During another portion of the cycle of the apparatus, the angular relationship is reversed by rotation of the bed 240 about axis 8. It should be noted that the sides 228a and 228b of upper sandwich plate 228, the sides 230a and 230b of lower sandwich plate 230, and the sides 208a and 208b of web path 208 are mutually parallel.

As also illustrated in FIG. 3a, the positioning bar 260 is supported by end supports 314a, 314b which lie outside of the web path 208, and locking bar 290 is seen to be relatively short, and to be located near one end (the near end) of positioning bar. Locking bar 260 is supported by two pins, one of which is designated as 292. A matching locking bar 290b is positioned near the other (far) end of positioning bar 260.

In general, a vacuum transfer head 280 having a trapezoidal shape matching the shape of the individual slitted trapezoidal sheets or sections 12 is used first to grasp the web 10, and then to pull the web 10 into a position in which cutter blade 272 can make the cut along knife gap 246 and therefore along a diagonal 14 on the web of FIG. 1. As illustrated in FIG. 3a, transfer head 280 includes a long side 280₁, a short side 280₂, and two other sides 280₃ and 280₄, which are not necessarily of the same length. In operation of the web cutting and individual sheet transfer portions of a method according to an aspect of the invention, the transfer head 280 does most of its translation near bed 240 at a height such that the positioning pins of sets 282a and 282b clear the upper edges of locking bars 290 and 290b of FIG. 3a, but as to bear against front surface 260fs of positioning bar 260 if they come into contact therewith.

The lower surfaces of sides or arms 280₃ and 280₄ of transfer head 280 of FIGS. 3a and 3b are fitted with vacuum apertures 390, and are also fitted with knife blade clearance grooves 391a and 391b, respectively. The indicated sides are those that engage the borders of the trapezoidal portions 12 of FIG. 1. FIG. 3c illustrates details of some of the vacuum ports 390 and part of the knife blade clearance groove 391b associated with nonparallel side 280₄ of head 280. Vacuum is applied to the transfer head at the time that the separated trapezoidal sheet is to be picked up.

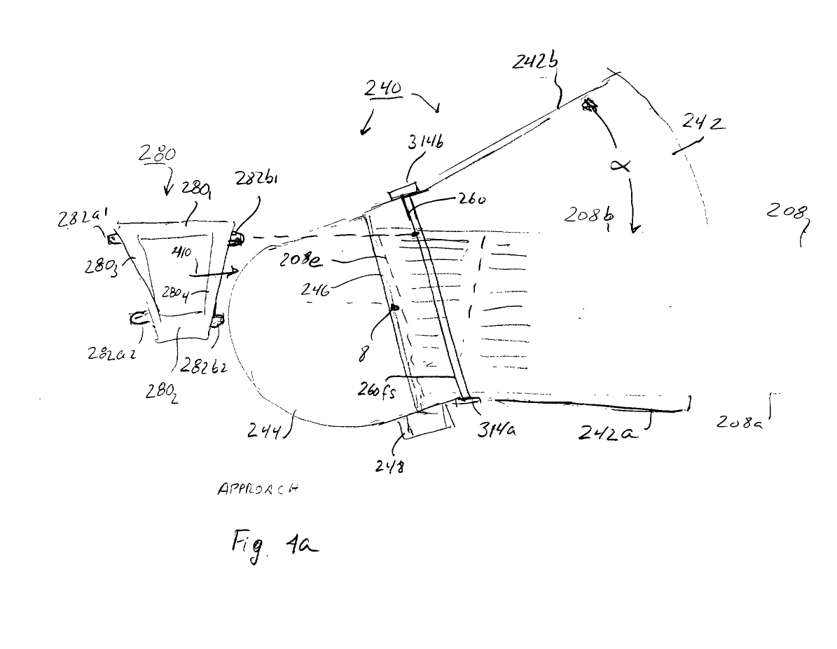

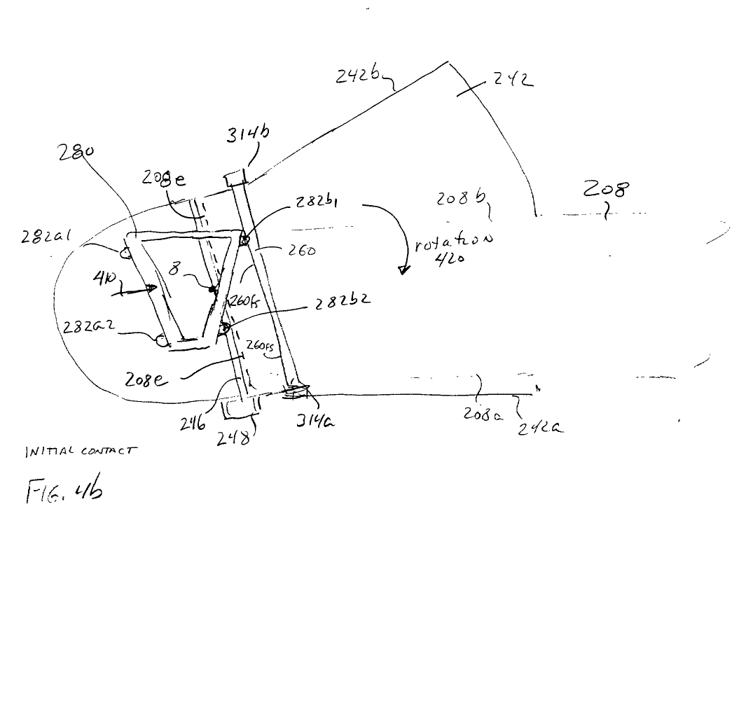

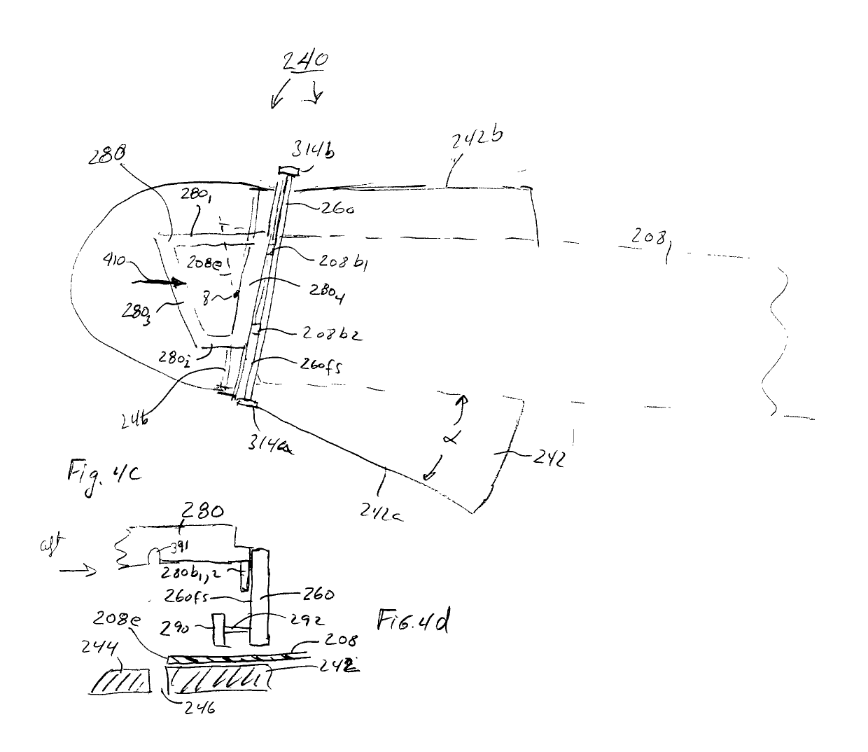

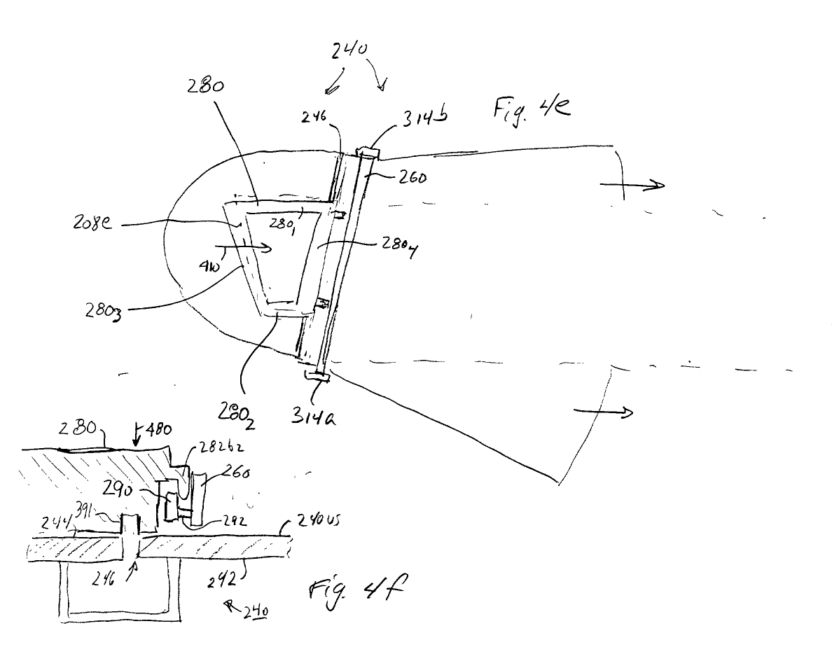

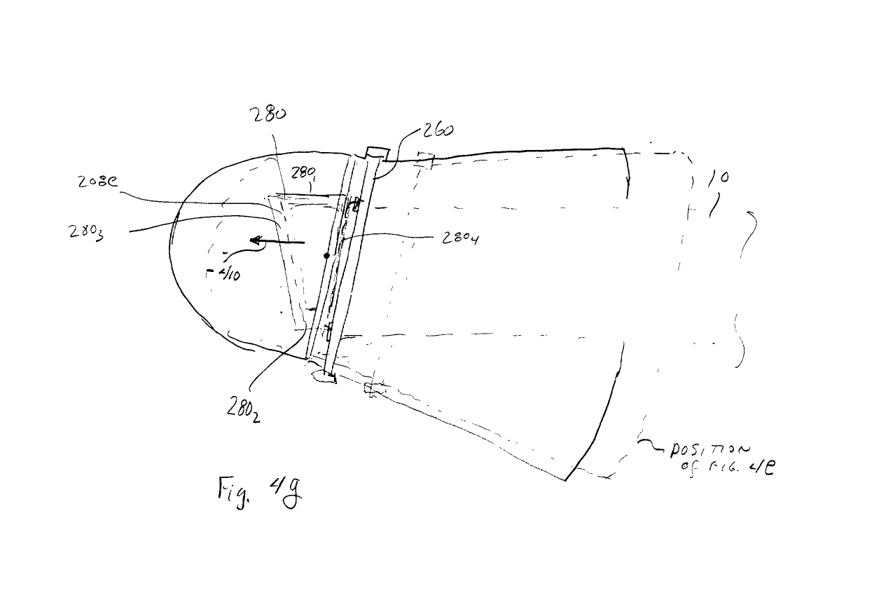

FIGS. 4a, 4b, 4c, and 4e are plan views which illustrate various positions which can be taken by the rotatable and translatable transfer head 280 and the rotatable and translatable bed 240 during the course of operation, and FIGS. 4d and 4f are side elevation views, partially cut away, to illustrate how the pins of the transfer head 280 interact with the positioning bar 260 and the locking bars 290.

In FIG. 4a, the transfer head 280 is returning to the web feeder and cutter arrangement of FIGS. 2a, 2b, and 3a to position the cutter, translate the cutter, pick up the cut trapezoidal sheet of material, and transport the cut sheet away to another stage of the machine, as suggested by FIG. 13. Brake 224 of FIG. 2 is engaged, to prevent incidental longitudinal movement of the web 10. As illustrated in FIG. 4a, the bed 240 is positioned in the “opposite” rotation relative to that illustrated in FIG. 3a, in that the angle between the edge 242b and the edge 208b of the web path 208 is α, and the side 242a is parallel with side 208a of web path 208. The cut end 208e of web, illustrated as a dash line, is parallel with, and adjacent to, cutting gap 246, as a result of the previous cutting cycle. In FIG. 4a, the transfer head 280 is moving in the aft direction indicated by arrow 410, as suggested by block 1314 of FIG. 3, at a height above the bed portion 244 sufficient for the pins 282b1 and 282b2 to clear the locking bars 290, 290b but low enough to bear on the front surface 260fs of the positioning bar, as suggested by block 1310 of FIG. 13. The rotational position (non-parallel side 280₄ leading) is selected to pick up a first orientation of trapezoid from the web, as suggested by block 1312 of FIG. 13.

In FIG. 4b, the transfer head 280 has translated in the direction of arrow 410 sufficiently to bring pin 282b1 of transfer head 280 into contact with the front surface 260fs of positioning bar 260, ready to begin rotation of the positioning bar and the attached bed 240 around axis 8, in the direction of arrow 420. The brake 224 of FIG. 2a continues set, to aid in preventing movement of the web. The bed 240 of FIG. 4b does not translate in the direction of arrow 410, notwithstanding its mounting on a translatable carriage 252 of FIG. 2a, because the friction brake 256 described in conjunction with FIG. 2a tends to resist such movement. The cut end 208e of the web 208 continues to be adjacent to, and parallel with, the cutting gap 246.

Between the times illustrated in FIGS. 4b and 4c, the positioning bar 260, together with bed 240 affixed thereto, rotates about axis 8 under the impetus of motion of transfer head 280 in the direction of arrow 410, with positioning pin 282b1 in contact with the front face 260fs of positioning bar 260. The bed 240 still does not move, because of the friction brake 256 of FIG. 2a, which makes the rotation the movement of least effort.

FIG. 4c illustrates the position of the bed 240, which is rotated back to the position of FIG. 3a, with angle α between side 242a of bed portion 242 and the edge of the web path 208, and with edge 242b parallel with the web path. At the time illustrated, positioning pin 282b2 of moving transfer head 280 has just come into contact with front surface 260fs, and further rotation of the bed 240 is prevented. At this time, the knife slot 246 lies under the clearance gap 391 of the transfer head 280. Also, the maximum rotation has been achieved, and the continuing further translation of transfer head 280 in direction 410 will result in translation of the bed 240 in the direction of arrow 410, without additional rotation. As the bed 240 and transfer head 280 move in the direction of arrow 410, the web 208 does not move in absolute terms, but instead slides relative to the moving bed 240 and transfer head 280. FIG. 4d is a side elevation view, partially cut away, to illustrate the height or vertical positions of the transfer head 280, the positioning bar 260, and the locking bars 290 under the conditions of FIG. 4c. As illustrated in FIG. 4d, the transfer head 280 continues at a relatively high position, sufficient for the pins 280b1, 280b2 to clear the locking bars 290.

FIG. 4e illustrates the result of continued translation in direction 410 of the transfer head 280, now moving together with both positioning bar 260 and with bed 240, to a point at which the end 208e of the web 208 extends to a location under that side 280₃ of transfer head 280 which is most remote from positioning bar 260. During this operation, the brake 224 illustrated in FIG. 2 is engaged to tend to prevent any retrograde movement of the web due to the motion of the various portions of the mechanism, and also to tend to prevent any incidental motion. Again, during the translation of transfer head 280 and the bed 240 to the position of FIG. 4e, the web does not move in absolute terms, but slides relative to the moving transfer head and bed. Side 280₄ of transfer head 280 continues to lie adjacent cutter gap 246. This is the greatest excursion of the transfer head 280 and bed 240 in aft direction 410. After the position illustrated in FIG. 4e is achieved, the transfer head is lowered in the direction of arrow 480, as suggested by block 1318 of FIG. 13, to a position similar to that illustrated in FIG. 4f, in which the positioning pins, such as 282b2, are lowered into the recess lying between the front surface 260fs of positioning bar 260 and the adjacent surface of locking bar 290, to thereby firmly affix the transfer head 280 to the bed 240, with the end of the web sandwiched therebetween. A vacuum is supplied to apertures 390 in the lower surfaces of sides 280₃ and 280₄ of transfer head 280, to thereby clamp that portion of the web lying under the transfer head firmly to the transfer head. Brake 224 of FIG. 2a is released.

Since the transfer head has a firm grip on the free end of web 10 and is also firmly affixed to the bed 240 by virtue of having its positioning pins engaged with positioning bar 260 and locking bars 290, it is now possible to put tension on the web 10 by moving transfer head in the forward direction indicated as—410 in FIG. 4g, as suggested by block 1320 of FIG. 13. Just before this motion begins, web brake 224 of FIG. 2a is released, to free the web for motion. Transfer head 280 is then moved in direction—410 sufficiently to advance the web, and to pull the bed 240 to a relatively forward position by the average dimension of one trapezoidal section of the web, which is the same dimension as the average width of a trapezoidal sheet 312. The result of moving the transfer head in direction—410, pulling the web 10 and the bed 240 with it, is illustrated in FIG. 4g, with the position of various portions indicated in phantom to illustrate the amount of motion. Once the position illustrated in FIG. 4g is achieved, forward translation is stopped, and brake 224 of FIG. 2a is reapplied, as suggested by block 1322 of FIG. 13. Knife 272 of FIG. 3 is activated, as suggested by block 1324 of FIG. 13, and the blade traverses the gap 246 to thereby separate that portion of the web 10 lying under the transfer head 280 from the remainder of the web 10, to thereby define a trapezoidal sheet, such as 312 of FIG. 3a, affixed to the underside of the transfer head 280. The transfer head 280 is then raised, as suggested by block 1326 of FIG. 13, thereby unlocking the head 280 from the bed 240, and carrying the trapezoidal sheet with the head.

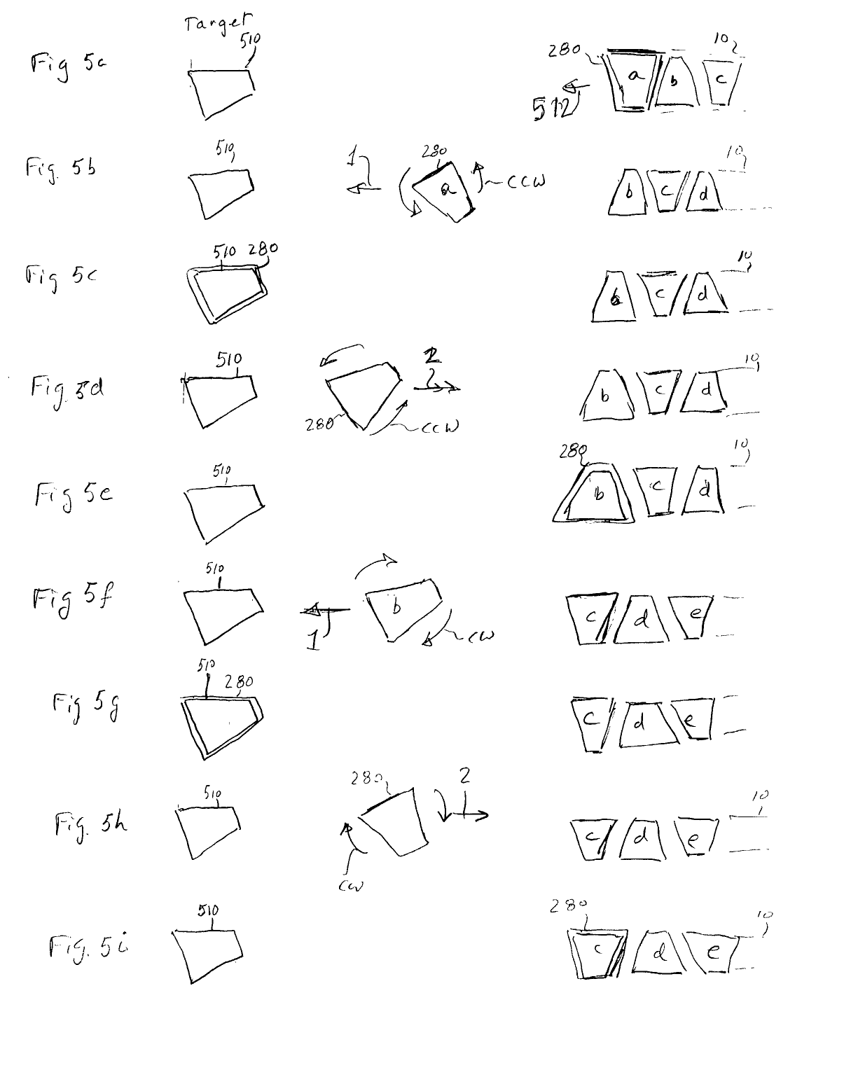

This completes a portion of one transfer cycle. As mentioned, alternate ones of the slitted trapezoidal portions of the web “point” in mutually opposite directions. In one application of the web cutting and transfer operation, the cut trapezoidal sheets are deposited in a particular fixed orientation at a trapezoidal sheet roll-up apparatus. In order to deposit the trapezoids in a fixed orientation, the transfer head must rotate during its operation to compensate for the alternating positioning of the trapezoids at the time of pick-up, as suggested by block 1328 of FIG. 13. FIGS. 5a, 5b, 5c, 5d, 5e, 5f, 5g, 5h, and 5i schematically illustrate the rotational motion of the head as it transfers trapezoidal sheets cut from the end of the web to a further workstation having a fixed orientation. The trapezoidal sections on the web are designated a, b, c, . . . In FIG. 5a, the target location 510 is at the left, spaced away from the web 10. The target location is oriented “pointing” to the right, whereas the trapezoids a, b, and c on the web 10 point up or down. At the time illustrated in FIG. 5a, the transfer head 280 overlies and holds separated trapezoid a, and is ready to begin moving in the direction indicated by arrow 512 toward the target location 510. When transfer head 280 carries away trapezoidal sheet a from the web 10, the next trapezoid among those remaining on the web 10 is trapezoid b. FIG. 5b illustrates the transfer head 280 moving in direction 1 on its way toward the target location 510, carrying trapezoidal sheet a. As it travels in direction 1 in FIG. 5b, transfer head 280 rotates about 90° (actually a bit more than 90°) counterclockwise (ccw) to match the pointing direction of the transfer head 280 and its trapezoidal sheet a to the orientation of the target location 510. FIG. 5c illustrates transfer head 280 overlying the target location 510, and transferring trapezoidal sheet a thereto. Transfer head 280 leaves target location 510, and proceeds in direction 2 toward the web 10, continuing to rotate in a counterclockwise direction, again by about 90° (actually, by somewhat less than 90°), as required to become aligned with upward-pointing trapezoidal sheet b. FIG. 5e illustrates transfer head 280 overlying trapezoidal sheet b, ready to pick it up. FIG. 5f illustrates transfer head 280 again moving in direction 1, but rotating about 90° in a clockwise (cw) direction so as to align trapezoidal sheet b with the target 510. By the time transfer head 280 returns to the target location with trapezoidal sheet b, the machinery associated with target 510 has already “used” trapezoidal sheet a, and is ready for another. FIG. 5g illustrates transfer head 280 overlying target location 510 as it transfers trapezoidal sheet b thereto. FIG. 5h illustrates transfer head 280 travelling in direction 2 on its way to pick up trapezoidal sheet c. Finally, FIG. 5i illustrates transfer head 280 overlying trapezoidal sheet c, ready to pick it up. This will be recognized as being the same situation as that illustrated in FIG. 5a, so another cycle can begin, corresponding to the cycle described in conjunction with FIGS. 5a through 5i. Thus, in general, the transfer head twice rotates about 90° in one direction, such as ccw, for a total of 180°, and then rotates twice in the cw direction by a like amount. Thus, there are never multiple complete revolutions, such as might result in winding up of power, control, vacuum, or air pressure cords or lines connected to the transfer head 280.

FIG. 13 is a simplified block representation of the control by control block 202 of FIG. 2 of the web cutting and transfer apparatus 200 of FIGS. 2, 3a, and 3b, of which blocks 1310 through 1328 have already been described. From block 1328, the control flows by way of a path 1330 to a further block 1332, which represents rotation of the transfer head 280 to the second pickup position, which is to say the position with nonparallel side 280₃ of transfer head 280 leading. From block 1332, the control logic proceeds to a block 1334, which represents translation of the transfer head in the aft direction 410. Blocks 1336, 1338, 1340, 1342, 1344, 1346, and 1348 correspond to blocks 1316, 1318, 1320, 1322, 1324, 1326, and 1328, respectively, with the only difference being in the orientation of the transfer head and trapezoidal sheet on the web. After the transport and deposit of the trapezoidal sheet as represented by block 1348 of FIG. 13, the control logic returns to block 1310 by way of path 1350 to begin another cycle.

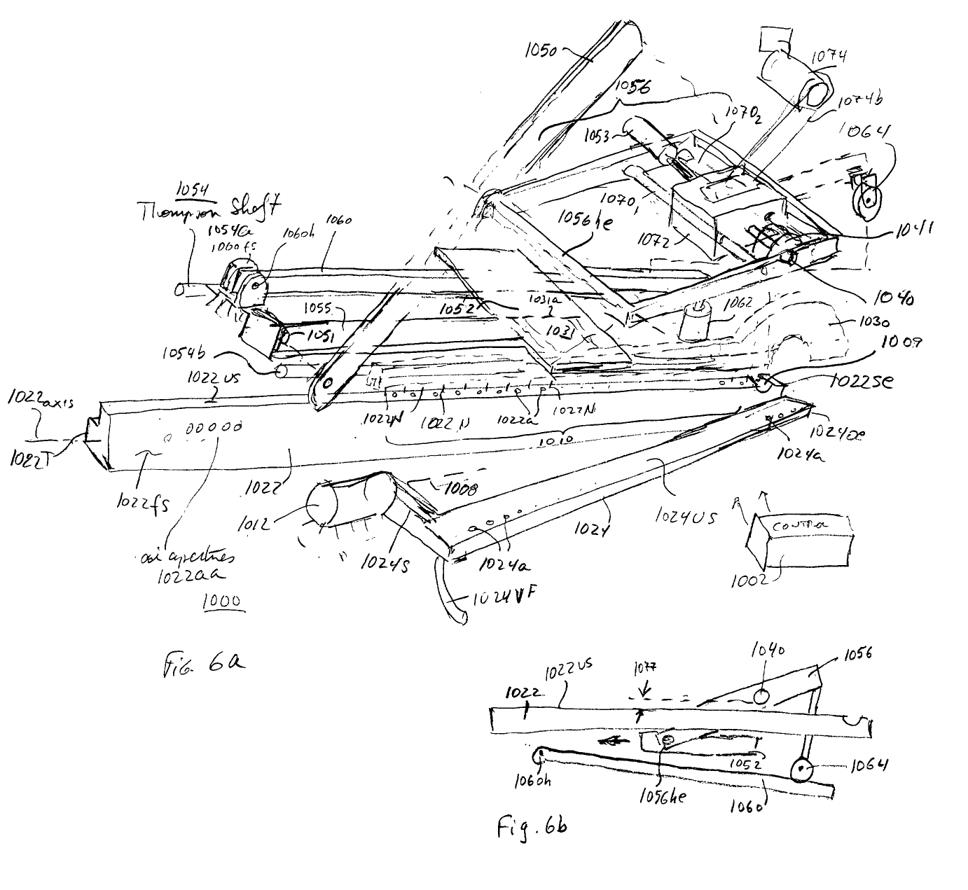

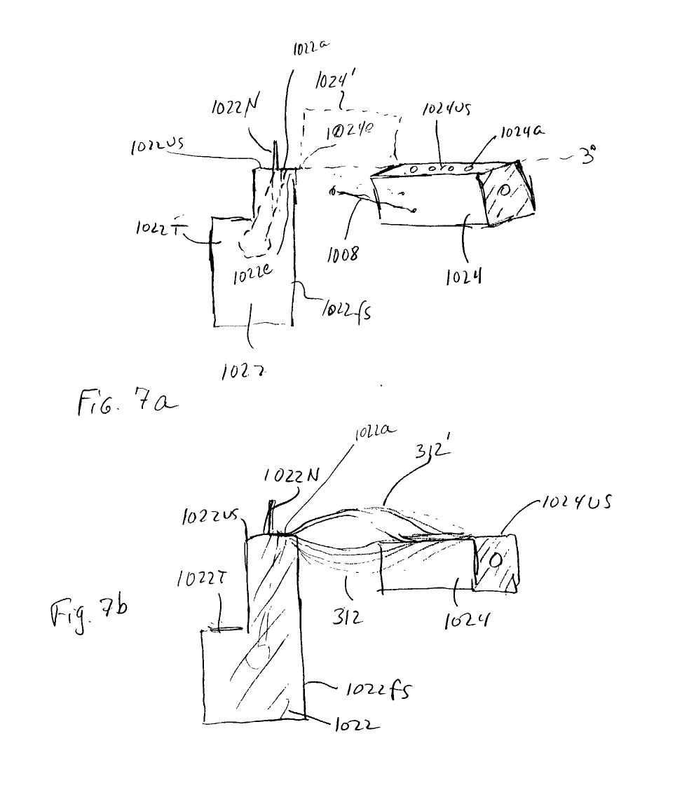

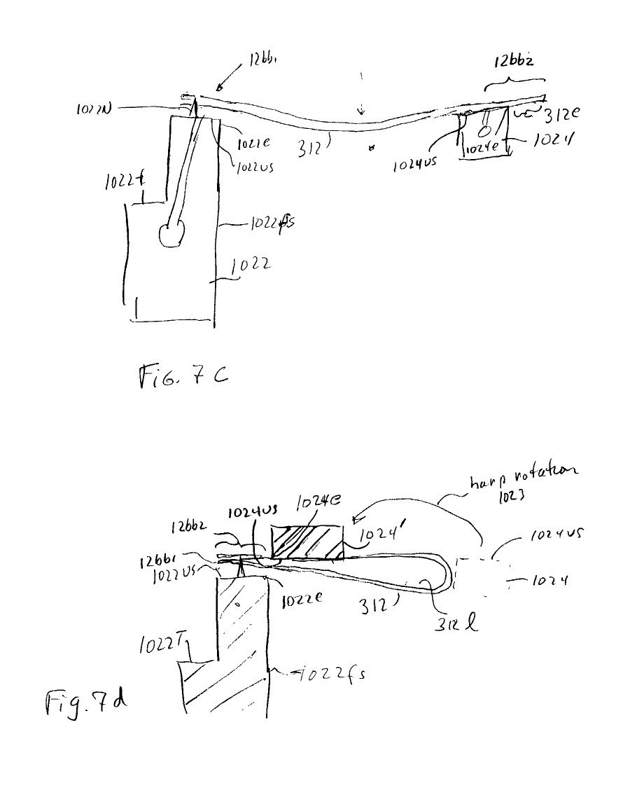

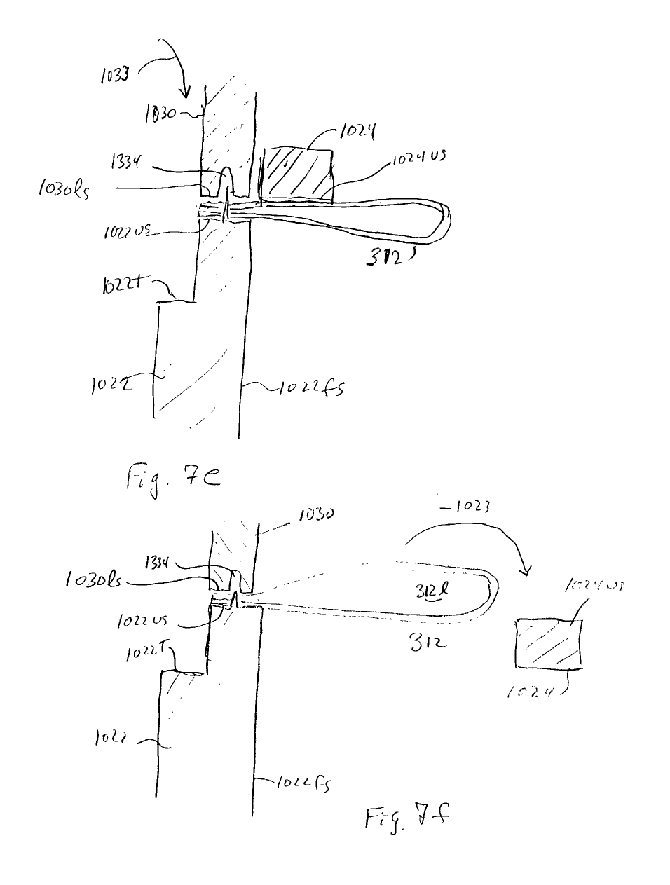

FIG. 6a is a simplified perspective or isometric view, partially exploded, of a roll-up portion 1000 of a bow-making machine, under the control of a synchronization or program arrangement designated generally as 1002. In FIG. 6a, an elongated roll-up bar 1022 defines an upper surface 1022us and a front surface 1022fs. Over a portion 1010 of its length, roll-up bar 1022 defines a plurality of vacuum apertures in its upper surface 1022us, some of which are designated 1010 in FIG. 6a. Near the starting end 1022SE of the roll-up bar 1022, a semicircular cut-out or clearance aperture 1009 provides clearance for a collet 1040. As illustrated in FIG. 6a, roll-up bar 1022 has a thicker portion 1022T in a region only partially visible.

While a particular embodiment of a bow-machine according to an aspect of the invention includes both a roll-up portion and a sheet cut-off and transfer portion, the roll-up portion 1000 of FIG. 6a is independent of the cut-off and transfer portion, and requires only that the trapezoidal sheets be placed on the harp 1024 and relevant portion 1010 of the roll-up bar 1022 in any manner.

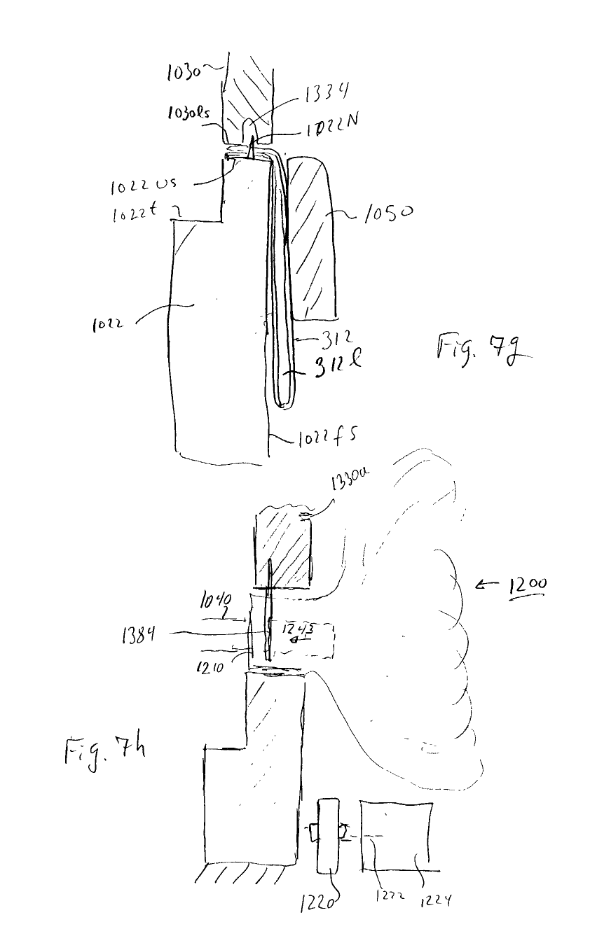

In FIG. 6a, a harp or folding bar 1024 actuated by a controllable rotary drive or motor 1012 is affixed to a harp support bar 1024S for rotation of the harp around an axis 1008. The other end 1024oe of the harp 1024 is not supported, or its support may be viewed as being a “virtual hinge” provided by the rigidity of the drive 1012 together with the support element 1024S. In its rest or loading position, illustrated in FIG. 6a, the upper surface 1024us is generally coplanar with the upper surface 1022us of the roll-up bar 1022, but there is a slight surface offset or skew, as illustrated in FIG. 7a. This surface offset or skew imposes an initial bow to the strip elements of the trapezoidal sheet when it is applied to the harp and roll-up bar, which tends to prevent unwanted “reverse” or upward bowing of the strip elements. In FIG. 7b, the harp 1024 is illustrated as having its upper surface 1024us coplanar with upper surface 1022us of the roll-up bar 1022, with the result that there is no bias to the position which the strips 13 of the trapezoidal sheet. Thus, in the absence of a bias, it is just as likely that the strips 13 of the trapezoidal sheet 312 will undesirably bow upward to the position shown as 312′ in FIG. 7b as they are to bow in the desired downward direction illustrated as 312 in FIG. 7b. Rotation of drive 1012 around axis 1008 of FIGS. 6a and 7a rotates the harp 1024 around axis 1008, and when completed brings the harp 1024 into the relationship with roll-up bar 1022 illustrated by the phantom view in FIG. 7a. In the position 1024′ illustrated in FIG. 7a, an edge of the harp 1024 is essentially coplanar with the front surface 1024fs of the roll-up bar. In operation of the roll-up portion of the bow-making machine, the trapezoidal transfer head 280 of FIGS. 2 AND 3, with the vacuum applied to its vacuum apertures 390, carries the individual trapezoidal sheet 312 to a location above the harp 1024 and associated portion 1010 of the roll-up bar, and deposits the trapezoidal sheet on the upper surfaces 1022us and 1024us of the roll-up bar 1022 and harp 1024, respectively, when the harp 1024 is in the rest, open, unfolded, or loading position illustrated in FIGS. 6a and 7a. Block 1410 of FIG. 14 represents the control step, by controller 1002 of FIG. 6a, of applying vacuum to the apertures 1022a of roll-up bar 1022 and to apertures 1024a of folding bar 1024 during the reception of the trapezoidal sheet 312 of workpiece, to hold the workpiece in proper position during the folding.

A set of upright pins or needles 1022N is placed along the upper surface 1022us of roll-up bar 1022 of FIG. 6a in the region 1010, to hold the juxtaposed edges or borders of the trapezoidal sheets 312 during a portion of the operation.

Also in FIG. 6a, a movable carriage or support plate 1052 is controllably slideable on a pair 1054 of mutually parallel bearing shafts 1054a, 1054b, extending parallel with an axis 1022ₐₓᵢₛ of elongation of roll-up bar 1022. Thus, carriage 1052 can be slidably moved parallel with the roll-up bar under the control of a motor and software. Carriage 1052 bears or carries a hinged end 1056he of a collet 1040 support structure designated generally as 1056, the hinge structure 1031 for a hold-down bar 1030, and the hinge structure 1051 for an element guard 1050. Thus, when the carriage 1052 translates, the collet support structure 1056, the hold-down bar 1030, and the element guard 1050 translate therewith.

Collet support structure 1056 of FIG. 6a includes a pair of bearing shafts 1070₁ and 1070₂ which extend perpendicular to the axis 1022ₐₓᵢₛ of elongation of the roll-up bar 1022. A collet slide carriage 1072 can slide on the bearing shafts 1070₁ and 1070₂ in a direction perpendicular to the direction of translation of carriage 1052, under the control of an air cylinder 1053, thus extending or retracting the collet 1040. The right end of the collet support structure 1056 of FIG. 6a can move upward and downward, depending upon the position of cam follower 1064 riding on bar 1060. This upward or downward motion, in turn, raises or lowers the collet 1040. Collet 1040 is controllably rotated by a timing belt 1074b from a controllable motor element illustrated as 1074.

Also in FIG. 6a, a hinged collet lift or support bar or cam 1060 is hinged 1060h at a fixed support 1060fs which is located generally at the left end of the structure 1000 of FIG. 6a. Bar or cam 1060 extends to the right in FIG. 1, and is connected to a collet lift air cylinder 1062 at the right of FIG. 6a. The right end of collet support structure 1056 is supported by a cam follower 1064 which rides on the upper surface 1060us of bar 1060. Lift cylinder 1062 lifts the right end of bar 1060 just before rolling of the folded trapezoidal sheet begins, to thereby lift the cam follower 1064, thereby lifting collet 1040 above the depressed clearance aperture 1009 in the roll-up bar 1022, to a highest position in which the lower edge of the collet clears the tips of needles or pins 1022N. When lift cylinder 1062 raises the right end of bar 1060 to this highest position, and maintains that position during roll-up, a residual upward slope remains in bar 1060. FIG. 6b is a simplified side elevation of a portion of the arrangement of FIG. 6a, illustrating the gap between the collet 1040 and the upper surface of the roll-up bar. The position of the collet 1040 is related by the cam follower 1064 to the position of the upper surface of bar 1060 at the particular position at which the collet is located relative to the roll-up bar 1022. Put another way, as the collet support structure 1056 translates to the left from the position illustrated in FIG. 6a, together with the collet 1040, the hold-down bar 1030, and the element guard 1050, the right end of the collet support structure 1056 tends to rise as the cam follower 1064 rises, thereby producing a gap 1077 between the collet 1040 and the upper surface 1022us of the fixed roll-up bar which tends to become larger over the duration of the roll-up process. This progressively larger gap accommodates the increasing diameter of the hub (1210 of FIG. 7h) of the bow (1200 of FIG. 7h) as it is rolled about the collet 1040.

A loop-element hold-down or guard illustrated as 1050 in FIG. 6a is hinged about an axis illustrated as 1051, and can be controlled between the illustrated upper position, in which the element guard 1050 is out of the way, to a second position, not illustrated in FIG. 6a, in which the element guard is essentially horizontally disposed, and located next to front surface 1022fs of roll-up bar 1022. Axis 1051 about which element guard 1050 rotates is associated with an axle (not illustrated) which is mounted on an extension 1055 of carriage 1052. Thus, the element guard 1050 moves or translates in conjunction with the carriage and with other elements carried by the carriage, such as the collet 1040 and the hold-down bar 1030.

FIG. 7c illustrates in cross-section the placement of the trapezoidal sheet 312 with one of its border regions, such as border region 12bb2 of FIG. 1, placed on portion 1010 (FIG. 6a) of the upper surface 1024us of harp 1024, with a portion 312e of the border 12bb2 extending beyond the edge of the upper surface 1024us, and with the other of its border regions, such as border region 12bb1 of FIG. 1, lying near or against upper surface 1022us of roll-up bar 1022. Instead of viewing the sheet 312 of material as being slightly oversize for the harp 1024, one may view the harp as being slightly undersize. The vacuum apertures 1024a in the upper surface of the harp 1024 hold the border of the trapezoidal sheet 312 to the harp, and the vacuum apertures 1022a in the upper surface 1022us of roll-up bar 1022 hold the sheet of material in place. If the transfer head 280 of FIGS. 2a, 3a, and 3b is used to transfer the trapezoidal sheet 312 to the harp and roll-up bar, the vacuum applied to the harp and roll-up bar should be applied concurrently with the turn-off of the vacuum to the transfer head. The vacuum applied to the upper surface 1022us of the roll-up bar 1022 and to the upper surface 1024us of the harp 1024us tends to hold the border regions of the trapezoidal sheet 312 to the harp and to the roll-up bar.

FIG. 7d is a cross-section of the roll-up bar 1022 and the harp 1024 of FIGS. 6a and 7a in the folded or rotated position, illustrating how the folding generates loops of sheet material in response to the folding command represented by 1412 of FIG. 14. In FIG. 7d, the harp 1024 is rotated 1023 about skewed axis 1008 (FIG. 7a) and has its upper surface 1024us juxtaposed with upper surface 1022us of the roll-up bar 1022. The illustrated offset of the harp 1024 from the upper surface 1022us of the roll-up bar 1022 is to leave room above the upper surface 1022us for descent of the hold-down bar 1030 (not illustrated in FIG. 7d).

Once folding has occurred by rotation of the folding harp 1024 around axis 1008 and two layers of the sheet material overlie portion 1010 of upper surface 1022us of the roll-up bar 1022, the border regions of the two layers of sheet material must be fastened together in preparation for the roll-up operation. The fastening may be accomplished by a layer of double-sided adhesive tape placed between the borders of the two layers, but in a preferred embodiment of the invention the fastening is accomplished by means of upright pins 1022N placed along the length of portion 1010 of the upper surface 1022us of roll-up bar 1022, as detailed in FIGS. 7a and 7b. As illustrated therein, the pins 1022N extend vertically upward from upper surface 1022us.

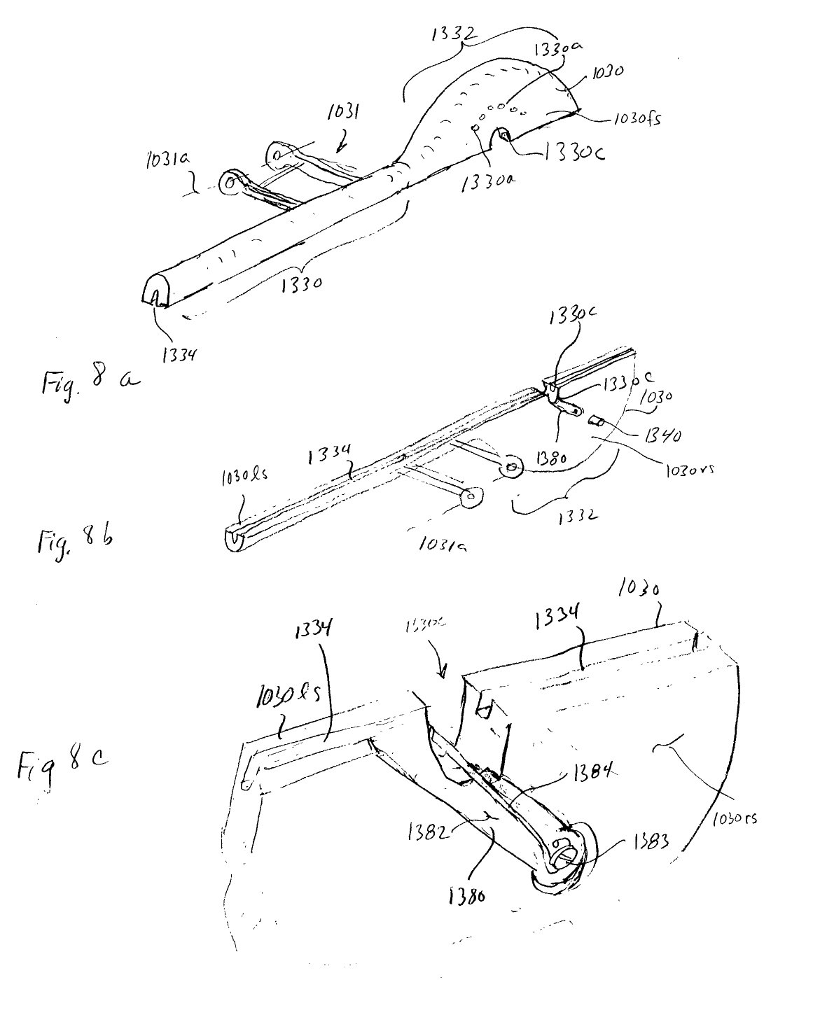

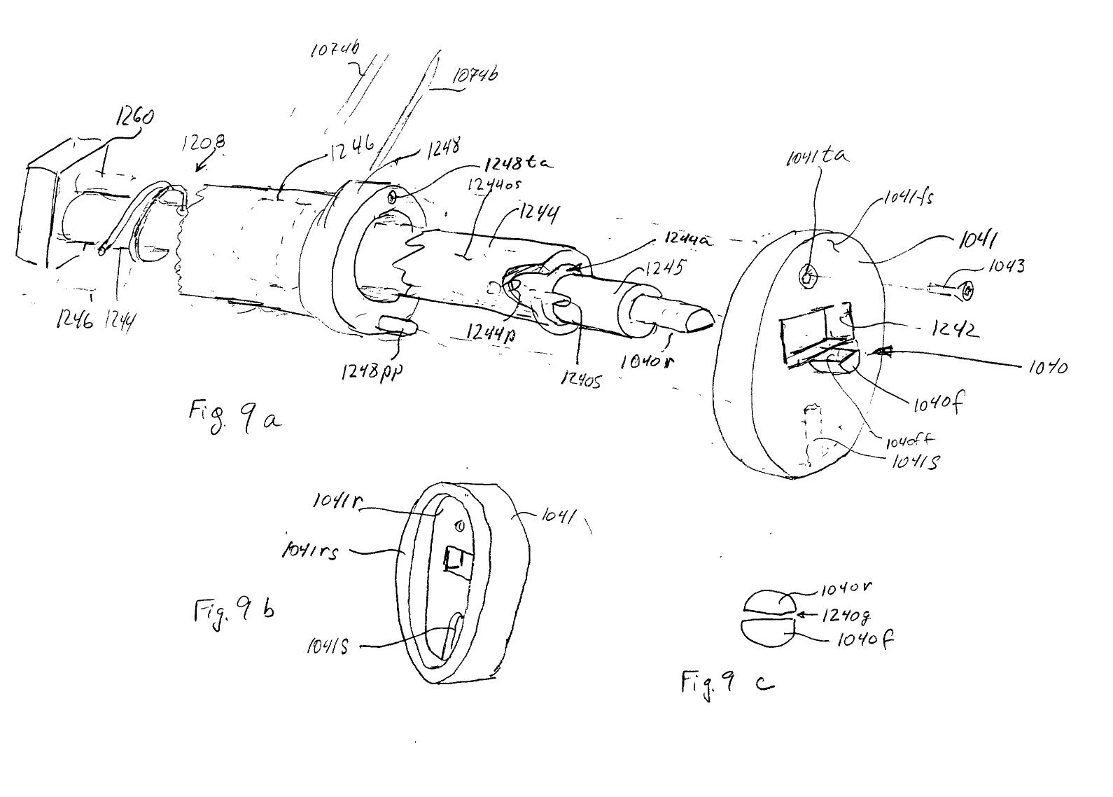

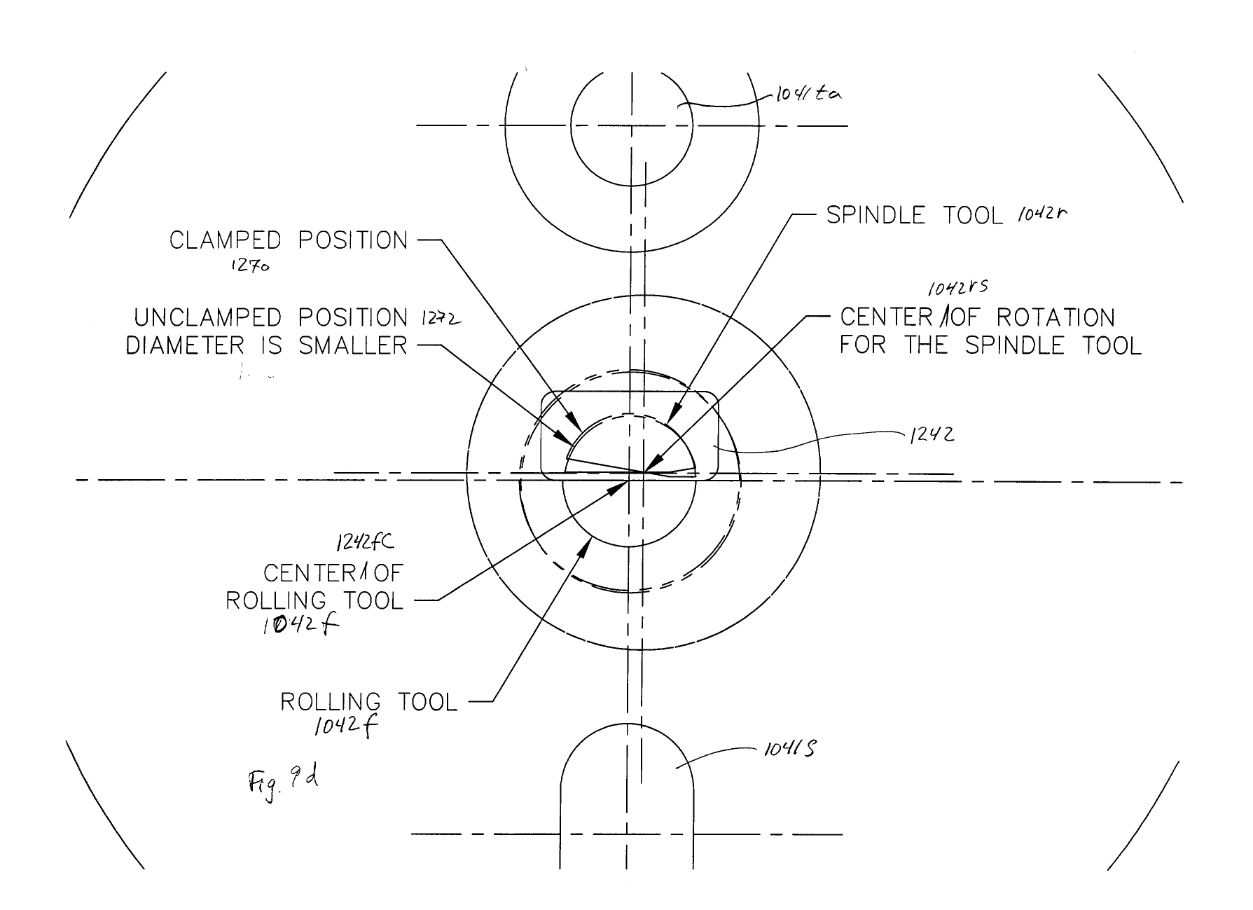

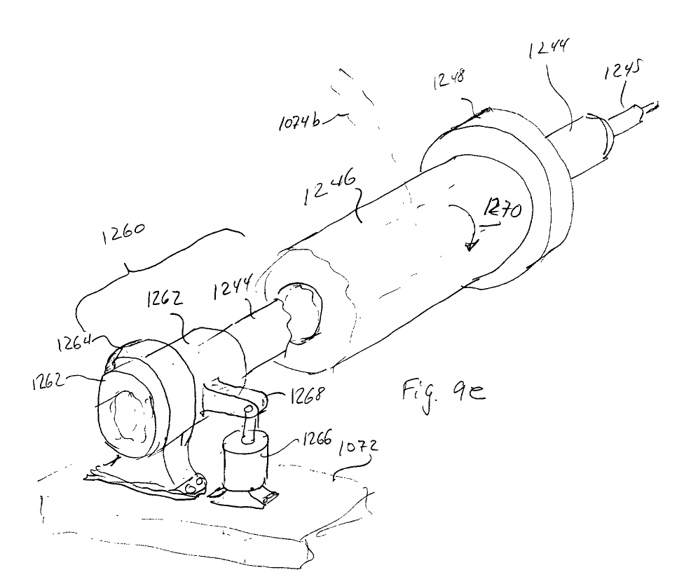

According to an aspect of the invention, a hold-down bar 1030 of FIGS. 6a and 8a, 8b, and 8c includes an elongated bar portion together with an enlarged head portion 1332. A hinge support structure is illustrated as 1031, which allows the hold-down bar 1030 to be rotated around an axis 1031a, while supported by an axle (not illustrated) supported, in turn, by movable carriage 1052 of FIG. 6a. Thus, hold-down bar 1030 can be raised somewhat relative to the roll-up bar 1022 of FIG. 6a by rotation around the axis 1031a of FIGS. 6a and 9, and traverses parallel with roll-up bar 1022 in conjunction with the movement of carriage 1052.

As illustrated in FIGS. 8a, 8b, and 8c, hold-down bar 1030 defines an elongated groove 1334, which extends along its entire length. Groove 1334 is dimensioned to clear pins 1022N when hold-down bar 1030 is in its lowermost position, with its lower surface against, or very close to, the upper surface 1022us of the roll-up bar 1022. After the harp 1024 has folded or rotated around axis 1008 and two layers of sheet material are juxtaposed over upper surface 1022us of roll-up bar 1022 in region 1010, as illustrated in FIG. 7e and as suggested by block 1412 of FIG. 14, the hold-down bar 1030 can be lowered (direction 1033 of FIG. 7e) under the command of a step illustrated as a block 1414 of FIG. 14, until its lower surface 10301s is juxtaposed with the upper surface 1022us of roll-up bar 1022. This presses the conjoined layers of sheet material 312 in the border region 12bb1 and 12bb2 down onto the pins 1022N to hold the two border regions together, without damaging the pins due to the clearance provided by groove 1334 in hold-down bar 1330. This step also defines a loop associated with each of the strips defined by the slits of FIG. 1, which loops are designated together as 3121. The loops are not creased, since there is no pressure on the looped end.

The clearance aperture 1330c defined in hold-down bar 1030 as illustrated in FIGS. 8a, 8b, and 8c is for clearing the region which may be occupied by the collet 1040 when the collet 1040 is extended for grasping the folded sheet material, and also provides additional clearance for purposes described below. The enlarged portion 1332 of the hold-down bar 1030 is provided as a flat “front” surface 1030fs against which the loops 3121 of sheet material can “flap” without damage during roll-up, and also to provide a surface through which air can be blown by way of apertures 1330a toward the end of the roll-up operation. The air inlet for apertures 1330a is illustrated as an air hose connection 1340 in FIG. 8b.

FIG. 8c is a perspective or isometric view of a portion of hold-down bar 1030, illustrating the lower surface 10301s and the groove 1334, and also illustrating a slot 1380 formed or milled in the “rear” surface 1030rs of the hold-down bar 1030 in the region 1332. As illustrated in FIG. 8c, the slot 1380 extends about half-way through the thickness of the material, and defines a generally planar slot lower surface 1382. A spring wire 1384 lies against slot lower surface 1382, and is held in place by a screw illustrated as 1383. The spring 1384 extends across a portion of the clearance aperture 1330c. The spring 1384 bears on the collet 1040 and on the hub of sheet material wound upon the collet 1040 during roll-up of the bow and during pick-up of the completed bow. This spring applies a radially inward force on the wound or partially-wound hub, which prevents the hub from unwinding during roll-up, at the time that the collet 1040 and hub being wound leave the last of the pins 1022N, and especially after roll-up is completed and transfer begins. The hold-down bar 1030, being ultimately supported by movable carriage 1052 of FIG. 6a, moves therewith. Since the collet also moves with carriage 1052, there is no relative motion between the collet 1040 and the hold-down bar 1030, except initial relative vertical motion of the collet due to the air cylinder 1062 of FIG. 6a in order to raise the collet above the pins 1022N, and additional gradual vertical motion due to the slope of bar 1060. The cutout or clearance aperture 1330c is dimensioned to accommodate both of these vertical motions of the collet. However, no transverse relative movement occurs between the collet 1040 and the hold-down bar 1030.

When the lower surface 10301s of hold-down bar 1030 is lowered to juxtaposition with the upper surface 1022us of the roll-up bar 1022 of FIG. 6a as suggested by block 1414 of FIG. 14, that end of sheet material 312 which lies near the right end of the roll-up bar 1022, as illustrated in FIG. 6a, extends through the center of conjoined clearance apertures defined by semicircular aperture 1009 in the upper surface 1022us and the more vertically-elongated clearance aperture 1330c defined in the enlarged head portion 1332 of hold-down bar 1330. At this time, the two conjoined layers of trapezoidal sheet material 312 extend across the conjoined clearance apertures 1009 and 1330c.

Following the lowering of the hold-down bar 1030 into a position with its lower surface 10301s juxtaposed with a portion of the roll-up surface 1022us of FIGS. 6a, 7a, and 7b, the vacuum applied to the apertures 1024a (FIG. 7a) on the upper surface 10242us of harp 1024 is turned off, as suggested by block 1415 of FIG. 14, to thereby release the trapezoidal sheet from the harp 1024 of FIG. 6a, so that the harp can be returned along a path, illustrated as—1023, to its unfolded or open position, illustrated in FIG. 7f, as suggested by block 1416 of FIG. 14.

Concurrently with, or after the harp 1024 is moved out of the way, as described in conjunction with FIG. 7f, the collet 1040 is moved or extended to a position in which it can grasp that portion of the conjoined sheets of material 312 extending across the conjoined clearance apertures 1009 and 1330c. Blocks 1418, 1420, 1422, and 1424 of FIG. 14 illustrate various steps in the extending of collet 1040 and its grasping of the conjoined border layers of trapezoidal material.

FIG. 9a illustrates details of the collet 1040 and the hub 1041 with which it is associated. In FIG. 9a, a “fixed” half-collet (half of a rolling tool) 1040f is in the form of a half-shaft extending from the front surface 1041fs of a disk 1041. As illustrated in FIG. 9b, disk 1041 defines a circular recess 1241r in its “rear” surface 1041rs. Disk 1041 also defines a clearance aperture for the other “rotating” or “rotatable” half-collet or spindle tool 1040r. The clearance aperture is illustrated as a rectangular aperture 1242, but may be of any shape. A half-collet drive and support element 1245 is illustrated as being separate from a drive and support shaft 1244, and as being coupled thereto by an axial aperture 1244a in the end of shaft 1244 and by an internal rotational-drive pin 1244p which engages in a corresponding slot 1240s in the half-collet drive and support element 1245. This coupling or separation is merely for the purpose of facilitating replacement of a wear element, which is the half-collet 1040r; thus, support element 1242 and drive shaft 1244 could be made in one piece.

Also in FIG. 9a, an outer drive shaft 1246 is associated with a coupling disk 1248. Coupling disk 1248 has an outer diameter which is no greater than the inner diameter of recess 1041r in the rear surface 1041rs of disk 1041, so that the coupling disk can fit therein. Coupling disk 1248 also has a projecting pin 1248pp which, when coupling disk 1248 engages recess 1041r, projects into a slot 1041s in recess 1041r, for providing positive rotational indexing and positive drive. Coupling disk 1248 also defines a threaded aperture 1048ta which is registered with a recessed through clearance aperture 1041ta in disk 1041, so that a screw 1043 can extend through the clearance aperture 1041ta to fasten disk 1041 to coupling disk 1248. With this arrangement, rotation of shaft 1044 can be accomplished independent of the rotation of shaft 1246, or put another way, while shaft 1244 must rotate with shaft 1246, it can be positioned rotationally relative to shaft 1246. This rotational positioning, in conjunction with the dimensioning of the various parts, results in a collet structure which has a larger diameter when grasping or clamping the border region of the trapezoidal sheet, and a smaller diameter when the sheet is released. Shaft 1246 is driven by timing belt 1074b of FIG. 6a, and its position can be indexed by control of the position of drive motor 1074.

FIG. 9c is an end view of a portion of the structure of FIG. 9a, illustrating details of the two half-collets 1040f and 1040r. As illustrated, fixed half-collet 1040f has a flat surface facing rotatable half-collet 1040r, while the surface of half-collet 1040r facing half-collet 1040f has a pair of flat surfaces. The rotation of movable half-collet 1040r relative to fixed half-collet 1040f can result in an open slot 1240g as illustrated in FIG. 9c, into which a sheet (or a doubled sheet) of trapezoidal material can be placed. Rotation of the rotatable collet or spindle tool 1042r relative to fixed collet or rolling tool 1042f in either direction causes gap to close, which grasps the trapezoidal sheet(s). FIG. 9d is a composite end view illustrating how the grasping and releasing of the trapezoidal sheet results in an increase and decrease, respectively, in the overall diameter of the collet 1040. In FIG. 9d, the center of rotation 1242fc of the “fixed” half-collet or half-rolling tool 1042f is spaced away from the center of rotation 1042rs of the “rotatable” half-collet or spindle toll 1042r. This offset of the center of rotation of the movable half-collet is accomplished by offsetting the axis of aperture 1244a relative to the axis defined by the outer surface 1244os of shaft 1244 of FIG. 9a.

The offset of the center of rotation of the fixed portion or rolling tool 1042f relative to the center of rotation of the movable portion or spindle tool 1042r results in a change in overall diameter of the collet 1040 in response to the grasping or releasing of the sheet material. In particular, referring to FIG. 9d, clockwise rotation of spindle tool 1042r (looking from the free end of the collet) relative to the fixed rolling tool 1042f results in an increase in the overall diameter of the combined collet portions, as suggested by the clamped position outline 1270, while the diameter 1272 in the unclamped condition is smaller. This reduction in diameter when unclamping the sheet material is useful in allowing the collet to be withdrawn from the hub of the bow when the bow is completed. A torsion spring arrangement, illustrated as 1208 in FIG. 9a, bears against the interior of outer drive shaft 1246 and on the exterior of support shaft 1244 to provide a bias which tends to rotate the spindle tool 1040r clockwise or into the grasping or closed position relative to fixed half-collet 1040f. The torsion spring arrangement 1208 causes a pre-load between collet 1040 and spindle tool 1040r, which tends toward the grasping position, in which the collet is at its larger diameter. A needle-bearing one-way or sprag clutch and air cylinder arrangement is illustrated as 1260 in FIG. 9a.

Details of one-way clutch and air cylinder arrangement 1260 of FIG. 9a are illustrated in FIG. 9e. In FIG. 9e, elements corresponding to those of FIG. 9a are designated by the same reference numerals. In FIG. 9e, the one-way clutch housing is illustrated as 1262, One-way clutch housing 1262 is rotatable within a housing or support 1264, which is fixed to slide carriage 1072 of FIG. 6a. The one-way clutch is rotatably positioned relative to the underlying slide carriage 1072 by means of an air cylinder 1266 which engages an arm 1268. Thus, one-way clutch 1262 is rotatable by a small angle relative to the shaft 1244. One-way clutch 1262 includes elliptical needle bearings which, as known, can allow free rotation of shaft 1244 in a first direction, but locks shaft 1244 to the clutch 1262 for the other direction of rotation. When outer shaft 1246 is driven in the direction of arrow 1270 of FIG. 9e for roll-up of the bow, shaft 1244 rotates in a direction in clutch 1262 which allows free motion, so shaft 1244 can rotate with shaft 1246. When roll-up is complete and the collet returns to the starting position, the timing belt 1074b moves shaft 1246 into a position in which the collet faces are horizontal. Then, air cylinder 1266 is operated to rotate clutch 1262 in the locked direction, to thereby rotate shaft 1244 in the direction of arrow 1272 of FIG. 9e, against the torque of spring 1208 of FIG. 9a, in order to open the collet 1040f, 1040r, as described in conjunction with FIG. 9d. The collet 1040 is then advanced on the sliding carriage 1072 to engage the trapezoidal web, and the air cylinder 1266 is then operated to return the one-way clutch to its original position. Return of the one-way clutch to its original position allows shaft 1244 to return to its original position under the impetus of spring 1208. The collet is then ready for rotation by way of timing belt 1074b and shaft 1246 as soon as the collet assembly is raised to clear the pins 1022N of FIG. 6a.

In operation of the roll-up machine portion 1000 of FIG. 6a, the placement of the trapezoidal sheet 312 on the harp 1024 and relevant portion 1010 of the upper surface 1022us of the roll-up bar 1022 causes the first layer of material to lie across the cut-out 1009 in the upper surface 1022us. When folding or rotation of the harp over axis 1008 occurs, a second layer of the sheet material overlies the first layer of material across cut-out 1009. Thus, in the region of the collet 1040 of FIG. 6a, the doubled layer of sheet material extends across the gap defined by cut-out 1009. The central shaft 1244 of FIG. 9a is rotated relative to outer shaft 1246 to thereby open the gap 1240g of FIG. 9c, and air cylinder 1053 of FIG. 6a is activated to extend collet 1040, with its open gap 1240g of FIG. 9c, toward or into clearance aperture 1022se of FIG. 6a. With the gap 1240g disposed horizontally, extension of the collet causes the fixed collet or rolling tool 1042f to slide under the layer(s) of sheet material, and rotatable collet or spindle tool 1042r to slide over the material. Of course, these could be in reversed positions, if desired. Rotation by a few degrees of the rotatable collet 1042r relative to the fixed collet 1042f causes the material to be clamped in the gap.

At the time when the folded sheet material is initially clamped in the gap 1240g (FIG. 9c) of collet 1040 of FIG. 6a, the center or axis of rotation of the collet 1040 is of necessity coplanar with the upper surface 1022us of rolling bar 1022. Consequently, translation of the collet 1040 along the surface 1022us is not possible, because breakage of the collet would likely result. Instead, the collet 1040, grasping the layer(s) of sheet material, is raised, as suggested by block 1428 of FIG. 14, until its lower surface is sufficiently above the rolling surface 1022us to clear the tips of fastening pins 1022N of FIG. 7f. The raising of the collet is accomplished by extension of air cylinder 1062 of FIG. 6a, which raises the right end of hinged bar or cam 1060, thereby raising the cam follower 1064, which is affixed to the right end of collet 1040 support structure 1056. As mentioned, even with the air cylinder 1062 holding the right end of hinged bar 1060 at an upper position, there remains a residual upward slope from the air cylinder (right) end of hinged bar 1060 to the hinge 11060h, for the purpose of raising the collet 1040 during roll-up to enlarge the gap between the collet 1040 and the upper surface 1022us of the roll-up bar 1022.

At some time after the return of the harp 1024 to the loading position, leaving the loop of sheet material 3121 affixed to the upper surface 1022us of the roll-up bar 1022, and before the roll-up begins, the element guard 1050 of FIG. 6a is rotated around its axis 1051, to a generally horizontal position adjacent the front surface 1022fs of the roll-up bar 1022, for the purpose of folding the loops of material out of the way and prevent jams. FIG. 7g illustrates the loops pushed aside by the element guard 1050 in its lowered position. The lowering of the element guard is represented in FIG. 14 by either of blocks 1417 or 1426.

With the element guard 1050 in place, and the collet raised to a non-interfering position, torque is applied to the collet 1040, now grasping the sheet material 312, as suggested by block 1430 of FIG. 14. A few milliseconds of delay (block 1432 of FIG. 14) are allowed for the torque to stabilize, and then translation is commanded of the carriage 1052, to the left as illustrated in FIG. 6a. The translation command is illustrated as block 1434 in FIG. 14. Since rotational torque is already applied to the collet 1040, roll-up or wind-up of the sheet material onto the collet begins as soon as translation begins. The collet 1040, the hold-down bar 1030, and the element guard 1050 all translate together, Thus, there is no relative motion between these elements, except for the slight rise of the collet as roll-up progresses. Concurrently with the roll-up, air under pressure may be blown from the apertures 1330a placed around the collet clearance aperture 1330c of the hold-down bar 1330, to tend to keep the moving loops in a “fluid” condition in which entanglement is reduced. The roll-up of the material continues until a predetermined position of the carriage is reached, at which the rolling is known to be completed, from the known size of the starting trapezoidal sheet 312. At this time, application of torque to the collet ceases, as suggested by the stop block 1436. The pressure or volume of the air blown from the apertures 1330a is preferably increased near the end of the roll-up procedure, to aid in preventing the loops from catching on the element guard 1050 as it rises out of the way.

In order to make the machine adaptable to different sizes of trapezoidal sheet material for making bows of different sizes, the translation of carriage 1052 continues to a stopping point which may be beyond the point at which roll-up occurs (block 1438 of FIG. 14). This has the advantage of providing a fixed stopping and unloading location for any size bow.

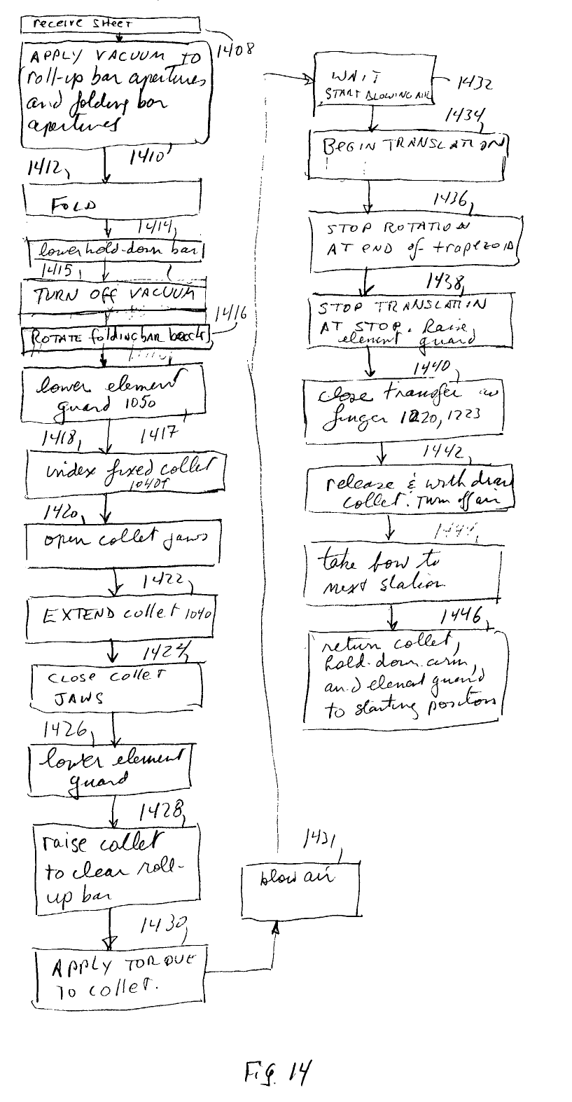

According to an aspect of the invention, the translation of the carriage 1052 and the associated collet 1040, hold-down arm 1030, and element guard 1050 is slow during initial portions of roll-up, and then faster during later stages of roll-up. The controller has continuous position information available to it, so all commands can be based upon exact position of the various elements. These positions can be expressed in terms of time. FIG. 11 illustrates a speed versus time plot 1110 of the commanded speed of the carriage 1052 and its associated parts. In FIG. 11, torque is applied to the collet 1040. At a slightly later time t1, after the torque has stabilized, acceleration is commanded to bring the speed of translation of the carriage 1052 to the speed designated “slow.” This speed is held until a position corresponding to time t3, at which another acceleration is commanded, to the “fast” speed. At a position corresponding to a time t5, the collet torque is turned off if the bow is smaller than the maximum-size bow that the machine is capable of accommodating. Motion or translation continues until a position corresponding to a time t6, at which the defined “stop” program is enabled, to cause the carriage to reach a complete stop at the desired location.

When the carriage reaches the stopping point, with the hub of the rolled bow wound about the collet 1040, air under pressure is blown from apertures 1022aa, on the front surface 1022fs of roll-up bar 1022 adjacent the unloading location, and air is additionally blown from air apertures 1330a in the hold-down bar 1330, to fluidize the loops of the bow.

Air may also be blown from an air jet or orifice 1287, mounted on the element guard 1050 as illustrated in FIG. 12, directing air in the direction illustrated by an arrow 1289, for the same purpose. Air may also be blown from jet or orifice 1287 during roll-up of the bow, if desired.

While air is blown on the loops of the bow, the element guard 1050 is raised (block 1438 of FIG. 14). The condition of the wound bow is illustrated in FIG. 7h. It should be noted that in the cross-section of FIG. 7h, the groove 1334 illustrated in FIGS. 7g, 8b, and 8c is not seen, as the groove does not extend into the cut-out region 1330c.

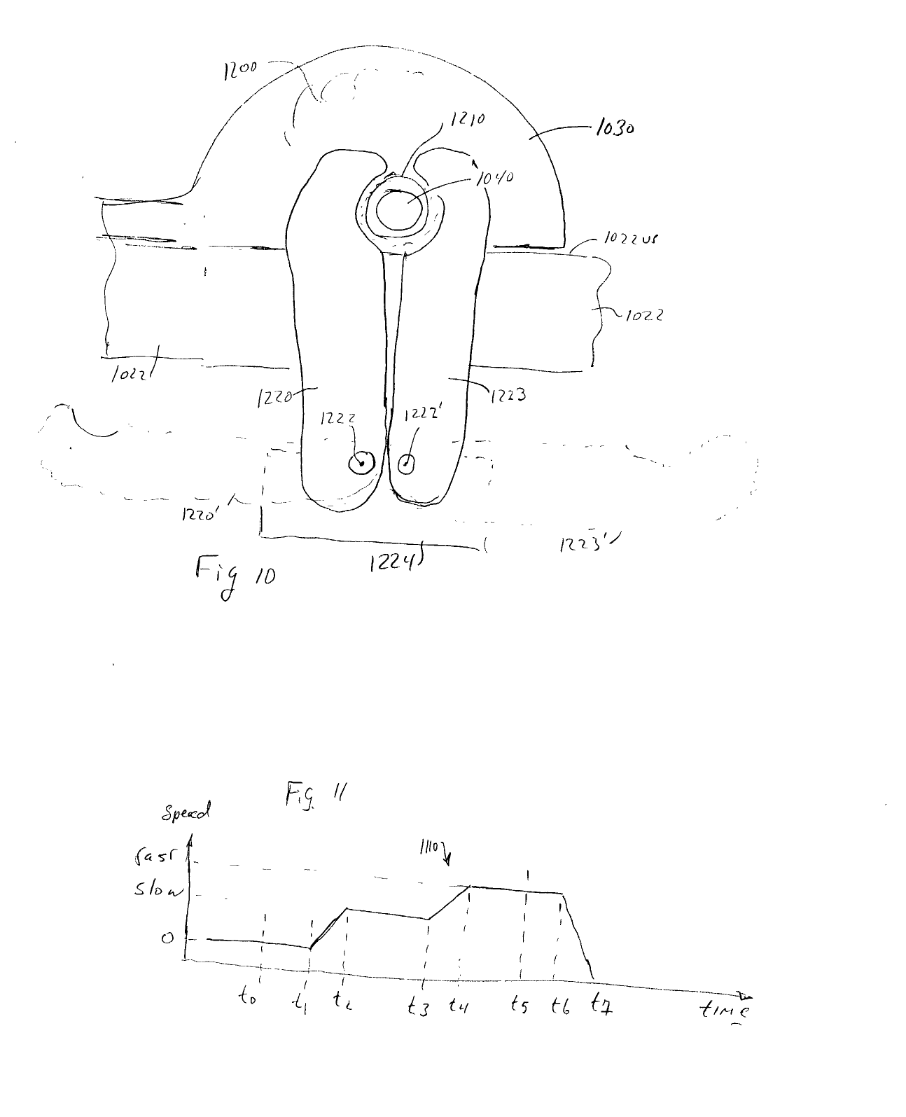

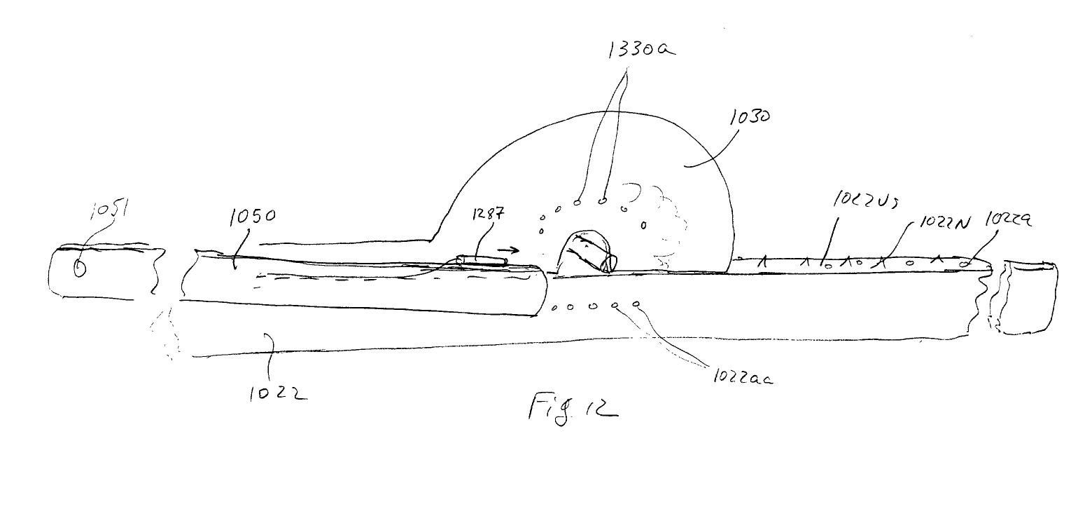

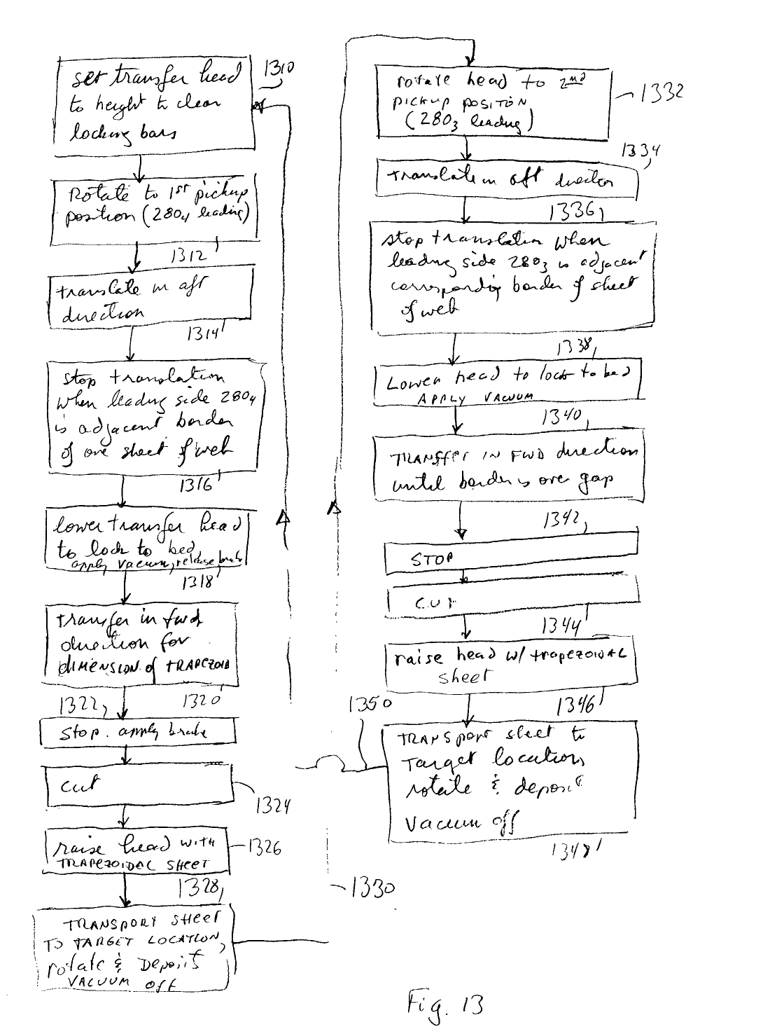

In FIG. 7h, the roll-up bar is illustrated as 1022, but has no pins 1022N because the pins do not extend to portions of the bar beyond region 1010 (FIG. 6a), since they are not needed in those regions. As illustrated, collet 1040 in the extended position has a hub 1210 of material wound thereabout, and that material splays out in the region to the right of the hub 1210 in FIG. 7h to define the wound bow 1200. As mentioned in conjunction with FIG. 8c, a spring finger 1384 attached to the hold-down 1030 bears against the hub 1210 of bow 1200 to aid in retaining it in the wound condition. A pair of transfer fingers, one of which is illustrated in its non-grasping position as 1220 of FIG. 7h, are hinged about axes, one of which is illustrated as 1222, and are mounted on a movable carriage 1224. The fingers are commanded to grasp the hub, as suggested by block 1440 of FIG. 14. FIG. 10 is a frontal view illustrating the finger 1220 of FIG. 7h in its grasping position, together with a mating finger 1223, hinged about an axis 1222′, also in its grasping position. The non-grasping position of fingers 1220 and 1223 is illustrated in FIG. 7h by phantom positions 1220′ and 1223′. Only the hub 1210 of the bow 1200 is illustrated, so as to avoid concealing features with the splayed loops of the bow. When the wound bow 1200 is grasped by the fingers 1220 and 1223 as illustrated in FIG. 10, the collet 1040 is commanded to its open or non-grasping position, which decreases its diameter. The command to release the collet is represented as a block 1442 in FIG. 14. The air may then be turned off. The collet 1040 is then retracted from the hub 1210, as suggested by the arrow 1243 in FIG. 7h, leaving the hub without a rigid center. The inherent outward spring of the web material may aid in keeping the hub tightly wound and against the transfer fingers 1220, and the transfer fingers 1220, 1223 hold it together during transport to another location (block 1444 of FIG. 14).

With the collet withdrawn, carriage 1224 of FIG. 10 can, in principle, move anywhere on that side of the plane of the front surface of roll-up bar 1022 which the carriage occupies. Naturally, it is desirable to keep equipment out of the path which the carriage 1224, fingers 1220, 1223, and bow 1200 may take in transporting the bow 1200 to the next station for fixing of the hub.

In a particular embodiment of the invention, the next stage of fabrication of the rolled bow is that of plunging the hub into a cup filled with hot-melt glue and allowing the glue to cool and harden, to thereby firmly hold the hub together and to provide a convenient handling surface. In this particular embodiment, the finishing operations are performed on an indexed turret or turntable which receives preprinted, prepunched adhesive-backed cards, punches a hole for accepting a heat-staking tab of a plastic cup, inserting the plastic cup and heat-staking it to the card, and, just before the hub of the bow is plunged into the cup, injecting hot-melt glue.

The collet, hold-down bar, and element guard can begin to translate back toward their starting positions as soon as the fingers have grasped the finished bow and the collet is retracted, as suggested by block 1446 of FIG. 14.

Other embodiments of the various aspects of the invention will be apparent to those skilled in the art. For example, while the web has been described as having a width of about 12 inches, so that the trapezoidal sheets have a length of about 12 inches, larger or smaller webs or sheets may be used, thereby making larger or smaller bows. While the described web transport scheme uses the dunnage to aid in unrolling web material from the feed roll, the web could be fed without the use of dunnage by using a lightweight free flange roller hanging in the slack loop, and the roll of web film would be driven to unroll the web. While the vacuum apertures have not been described as being connected to vacuum sources by way of controllable valves, such connections are well known and need no further explanation. While the individual sheets of film have been described and illustrated as trapezoids, the term should be understood to include rectangular sheets of material, which makes a “fountain” bow, rather than a “fireworks” bow having a depressed center or axial region. While relative times for the various operations have been described, those skilled in the art will recognize that actions which are described as being performed in time sequence should be, to the extent possible, performed concurrently, to minimize cycle time. In an actual embodiment of the invention, the incoming web has registration markings every second trapezoid, and these markings are used to slightly adjust the amount of fore-aft travel of the transfer head while locked to the rotatable bed, in order to tend to maintain the registration marks in the same relative location.

A web cutting apparatus (200) according to an aspect of the invention is for cutting individual trapezoidal sheets (312) from an end of the web (10) includes a movable carriage (252) movable in a fore-aft direction (254), and a generally horizontal rotatable bed (240) mounted on the movable carriage (252). The rotatable bed (240) is rotatable about a vertical axis (8) on the movable carriage (252). A web (10) cutter (270) is affixed to the rotatable bed (240). The cutter (270) cuts along a cutting path (246) making a fixed angle (essentially 90° in the example) across the rotatable bed (240). A positioning surface (260fs) affixed to the rotatable bed (240) extends parallel with the cutting path (246). A trapezoidal transfer head (280) defines first (280₃) and second (280₄) non-parallel sides. The transfer head (280) is rotatable about a vertical axis (5), and movable in at least the fore-aft direction (254). A brake (256) is connected to the carriage (252), for tending to resist, but not totally prevent, motion in the fore-aft direction (256). A control arrangement (202) is coupled to the transfer head (280) and to the web (10) cutter, for sequentially (a) moving the transfer head (280) in the aft (410) direction (1314) with a first orientation (280₄ first or leading), such as to bring a first of the non-parallel sides (280₄) into contact with the positioning surface (260fs), whereby the positioning surface (260fs) rotates into parallelism with the first (280₄) of the non-parallel sides, (b) moving the transfer head (280) in the aft (410) direction (1314) against the force of the brake (256) after the positioning surface (260fs) is parallel with the first non-parallel side (280₄) of the transfer head (280), to thereby move the rotatable bed (240) in the aft direction, (c) locking (1318) the transfer head (280) to the rotatable bed (240) and to the web (10), (d) moving the transfer head (280) in the fore or forward direction (1320), carrying the rotatable bed (240) and the web (10) therewith, (e) for a distance equal to the dimension of a trapezoid in the fore direction, and then stopping the motion (1322) in the fore direction, (f) actuating the web (10) cutter (1324) to thereby cut that portion of the web (10) lying under the transfer head (280) from the remaining portion of the web (10) and define a separated trapezoidal sheet, and (g) releasing (1326) the transfer head (280) from the rotatable bed (240), while continuing to lock the transfer head (280) to the separated trapezoidal sheet.

In a particular version of this web (10) cutting apparatus (200), the control arrangement (202) is further for moving the transfer head (280) with the separated trapezoidal sheet to a target location (1328), and depositing the separated trapezoidal sheet at the target location. In this particular version, the control arrangement (202) is further for (a) rotating the transfer head (280) around the vertical axis (1322), and moving the transfer head (280) in the aft direction (1324) with a second orientation such as to bring a second of the non-parallel sides into contact with the positioning surface (260fs), whereby the positioning surface (260fs) rotates into parallelism with the second of the non-parallel sides, (b) moving the transfer head (280) in the aft direction (1334) against the force of the brake (256) after the positioning surface (260fs) is parallel with the second non-parallel side of the transfer head (280), to thereby move the rotatable bed (240) in the aft direction, (c) locking 1336, 1338) the transfer head (280) to the rotatable bed (240) and to the web (10), (d) moving the transfer head (280) in the fore direction (1340), carrying the rotatable bed (240) and the web (10) therewith, (e) for a distance equal to the dimension of a trapezoid in the fore direction, and then stopping the motion (1322) in the fore direction (f) actuating the web (10) cutter (1344) to thereby cut that portion of the web (10) lying under the transfer head (280) from the remaining portion of the web (10) and define a second separated trapezoidal sheet, and (g) releasing (1346) the transfer head (280) from the rotatable bed, while continuing to lock the transfer head (280) to the second separated trapezoidal sheet. Following this sequence of steps, the control arrangement (202) is further for moving (1348) the transfer head (280) with the second separated trapezoidal sheet to the target location, and depositing the separated trapezoidal sheet at the target location. In this version, the control arrangement (202) is further for rotating the transfer head (280) about the vertical axis in conjunction with moving the transfer head (280) with the first separated trapezoidal sheet to the target location.

A particular variant of the web (10) cutting apparatus (200) further including a controllable web (10) brake (256) for controllably braking the web (10) In this particular variant, the control arrangement (202) is further for setting the web (10) brake (256) at all times except that time beginning at which the transfer head (280) begins to move in the fore direction locked to the web (10) and ending at the time of cutting.

Another avatar of the web (10) cutting apparatus (200) further comprises a web (10) loop control (214, 220, 216) for tending to maintain a minimum length of hanging loop (214) of web (10) for reducing frictional forces on the web (10) during that time during which the web (10) moves in the fore direction locked to the transfer head (280).

According to another aspect of the invention, a web (10) cutting and sheet transfer apparatus comprises an advancing arrangement for advancing the web (10) material onto a cutting bed, a cutting arrangement for sequentially cutting individual trapezoidal sheets (312) from an end of the web (10), where the cutting arrangement comprising a cutting element mounted below the cutting bed for controllably cutting along a path associated with the cutting head (280). A cutting bed (240) rotating arrangement is coupled to the cutting head (280), for rotating the cutting bed (240) by a selected amount (±α) between cuts, so that cuts at various angles across the web (10) material sequentially create individual trapezoidal sheets, alternately oppositely oriented on the cutting bed (240). A transfer arrangement (280) is associated with the cutting arrangement. the transfer arrangement includes a transfer head (280) having the same general (trapezoidal) shape as the individual trapezoidal sheets (312), and also includes an arrangement (controllable vacuum and apertures) for controllably attaching the individual trapezoidal sheets (312) to the transfer head (280), at least along a border ((12bb1, 12bb2) of the individual trapezoidal sheets (12b), for sequentially picking up the individual trapezoidal sheets, and transferring the individual trapezoidal sheets (312) to a location (1000) remote from the cutting bed (280). A transfer rotation arrangement is coupled to the transfer arrangement (282), for rotating (6) the transfer head (280) so that the individual trapezoidal sheets (312) sequentially transferred to the remote location (1000) are placed at the remote location in the same orientation.

According to another aspect of the invention, an apparatus (1000) is for rolling ornamental objects (1200) from individual sheets (312) of trapezoidal material defining plural border regions (12bb1, 12bb2). The apparatus (1000) comprises a fixed roll-up bar (1022) defining a flat, straight upper surface (1022us), and a movable folding bar (1024) defining a generally straight, flat surface. The movable folding bar (1024) is rotatable around an axis (1008) from a first position (FIG. 7c) to a second position (FIG. 7d), so as to bring an edge (1024e) of the movable folding bar (1024) into juxtaposition with an edge (1022e) of the flat, straight surface (1022us) of the roll-up bar (1022), and so that the movable folding bar (1024) does not cover the flat, straight surface (1022us) of the roll-up bar (1022). The movable folding bar (1024) further includes a controllable affixation arrangement (1024a), adapted for holding at least a portion of one of the border regions (12bb1, 12bb2) of an individual trapezoidal sheet (12b) of workpiece material against the movable folding bar (1024). In one version of this aspect of the invention, the controllable affixation arrangement (1024a) includes apertures on the movable folding bar (1024) to which vacuum is controllably applied. A folding arrangement (1012) is coupled to the movable folding bar (1024), for rotating the movable folding bar (1024) into juxtaposition with the edge (1022e) of the flat, straight surface (1022us) of the roll-up bar (1022), as a result of which, or whereby, at least a portion of one of the border regions (12bb2) of the individual trapezoidal sheet (12b) is juxtaposed with at least a portion of another one of the border regions (12bb1) of the individual trapezoidal sheet (12b). A temporary affixation arrangement (1022N) is associated with the roll-up bar (1022), for at least temporarily holding together the juxtaposed border regions (12bb1, 12bb2) of the individual trapezoidal sheet (12b). In one version of this aspect of the invention, the temporary affixation arrangement includes a plurality of pins (1022N) projecting above the flat, straight surface (1022us) of the roll-up bar (1022). A grasping collet (1040) is provided for grasping the juxtaposed border regions of the individual trapezoidal sheet. The collet (1040) is controllably rotatable and translatable from a starting position. A movable trapezoidal sheet hold-down bar (1030) is movable with respect to the flat, straight surface (1022us) of the roll-up bar (1022). The trapezoidal sheet hold-down bar (1030) includes a straight surface (10301s) for, when the straight surface (10301s) of the trapezoidal sheet hold-down bar (1030) is juxtaposed with the flat, straight surface (1022us) of the roll-up bar (1022), tending to hold the juxtaposed border regions (12bb1, 12bb2) of the individual trapezoidal sheet in communication with the affixation arrangement (1022N). A control arrangement (1002) is provided for, when a single trapezoidal sheet is placed on the movable folding bar (1024) in the first position thereof, performing the steps of (a) causing the folding arrangement to operate (1412) to thereby fold the trapezoidal sheet to form a folded trapezoidal sheet, (b) causing the movable trapezoidal sheet hold-down bar (1030) to move (1414) relative to the flat, straight surface (1022us) of the roll-up bar (1022) to become juxtaposed therewith, for tending to hold the juxtaposed border regions (12bb1, 12bb2) of the individual trapezoidal sheet (12b) in communication with the affixation arrangement (1022N), (c) causing the collet to grasp the juxtaposed border regions (1418, 1420, 1422, 1424) of the individual trapezoidal sheet, (d) causing the collet to rotate in conjunction with translation of at least the collet (1430, 1432, 1434) along a path generally parallel (but which may have a slope) with the flat, straight surface (1022us) of the roll-up bar (1022), whereby at least the juxtaposed border portions of the individual trapezoidal sheet are wound on the collet (1040) to define a hub, (e) stopping the rotation of the collet (1436) and the translation (1438), (f) grasping the hub (1210) with a transfer apparatus (1220, 1223) while removing the collet (1440) from the hub (1210), and (g) moving the trapezoidal sheet hold-down bar (1030) from the juxtaposition, translating the collet to its starting position, and causing the movable folding bar (1024) to move to the first position (1446).

In a particular avatar of this aspect of the invention, the affixation arrangement comprises a plurality of pins (1022N) extending orthogonally from the flat, straight surface (1022us) of the roll-up bar (1022), and the flat, straight surface (10301s) of the trapezoidal sheet hold-down bar (1030) defines an elongated groove (1334) dimensioned to clear the pins (1222N) when the flat, straight surface (12301s) of the trapezoidal sheet hold-down bar (1030) is juxtaposed with the flat, straight surface (1022us) of the roll-up bar (1022).

In another avatar of this aspect of the invention, the starting position of the collet lies in a cutout (1009) in the flat, straight upper surface (1022us) of the roll-up bar (1022), and the control arrangement (202) causes the collet to translate substantially vertically (1428) (actually along an arc) to a location above the cutout (1009) before the step (1430, 1432, 1434) of causing the collet to rotate in conjunction with translation of at least the collet along a path generally parallel with the flat, straight surface of the roll-up bar (1022).

In yet another avatar of this aspect of the invention, the controllable affixation arrangement (1024a) associated with the movable folding bar (1024) comprises a plurality of controlled-vacuum apertures adapted for holding at least a portion of one of the border regions of an individual trapezoidal sheet, and the control arrangement (202), after the step of causing the movable trapezoidal sheet hold-down bar (1030) to move relative to the flat, straight surface of the roll-up bar (1022) to become juxtaposed therewith, performs the additional step (1415) of turning off the vacuum in the controlled-vacuum apertures.

In a further avatar of this aspect of the invention, the control arrangement (202), in conjunction with the step (1430, 1432, 1434) of causing the translation of at least the collet (1040) along a path generally parallel with the flat, straight surface (1022us) of the roll-up bar (1022), further causes the translation of the trapezoidal sheet hold-down bar (1030) generally in consonance with the translation of the collet (1040).

In a further avatar of this aspect of the invention, the fixed roll-up bar (1022) defining a flat, straight upper surface (1022us) further defines a front surface (1022fs) generally orthogonal to the flat, straight upper surface (1022us), and the apparatus further comprises an element guard (1050) hinged along an axis (1051) generally orthogonal to the front surface (1022fs), and movable from a disengaged position (up) to an engaged position, in which the element guard (1050) lies adjacent to the front surface (1022fs). In this further avatar, the control arrangement (202) further performs the step, prior to the step (1430, 1432, 1434) of causing the collet to rotate in conjunction with translation, of moving the element guard to the engaged position (1417 or 1426).

According to a yet further avatar of this aspect of the invention, the apparatus further comprising an element guard (1050), and the control arrangement (202), in conjunction with the step of causing translation (1434) of at least the collet (1040) along a path generally parallel with the flat, straight surface (1022us) of the roll-up bar (1022), further causes the translation of the element guard (1050) generally in consonance with the translation of the collet (1040).

According to another aspect of the invention, a method for making a bow from individual trapezoidal sheets (312) of material by means of a machine, starts with sheets of material which define at least generally parallel slits or cuts (C) extending between border regions to thereby define generally parallel strips (S). The method according to this other aspect of the invention comprises the step of applying each trapezoidal sheet (312) to a folding apparatus including at least a portion of a roll-up surface (1022us) of a fixed roll-up element (1022) and a movable folding element (1024) which, when folded, is juxtaposed with an edge (1022e) of the roll-up surface (1022us), but which does not fully extend thereover. The applying of each trapezoidal sheet (312) is performed in such a manner that a border portion (312e of 12bb1, 12bb2) of the trapezoidal sheet (312) extends beyond the folding element (FIG. 7c), whereby, when the folding portion (1024) of the folding apparatus is folded toward the roll-up element (1022), at least a border region (312e) of the folded trapezoidal sheet (312) is exposed above the roll-up surface (1022us). The movable element (1024) of the folding apparatus is folded or moved (1412) to a folded position (FIG. 7d), thereby bringing the borders of the trapezoidal sheet into juxtaposition over the roll-up surface (1022us) of the roll-up element (1022), and forming the strips (S) into loops (3121). A hold-down bar (1030) is moved (1414) toward the roll-up surface (1022us) of the roll-up element (1022), to thereby press together the juxtaposed border regions (12bb1, 12bb2) of the folded trapezoidal sheet (312). An element guard (1050) is rotated or translated (1417 or 1426) in a first direction generally parallel with a front surface (1022fs) of the roll-up element (1022), to a position in which portions of the loops (3121) of the trapezoidal sheet (312) remote from the hold-down bar (1030) extend generally parallel (FIG. 7g) with the front surface (1022fs) of the roll-up element (1022). The juxtaposed border regions of the folded sheet (312) are grasped (1418, 1420, 1422, 1424) with a rotatable collet (1040) at a location near a first end (small end in the example) of the folded trapezoidal sheet. The collet (1040) is simultaneously rotated and translated (1430, 1432, 1434) toward a second end (the large end), opposite to the first end, of the trapezoid sheet. The hold-down bar (1030) and element guard (1050) are also translated toward the second end of the trapezoidal sheet to thereby form the ornamental bow (1200). The ornamental bow (1200) has a hub (1210) wound about the collet (1040). The element guard (1050) is translated (1438) in a second direction, opposite to the first direction, to get it out of the way. The hub (1210) of the ornamental bow (1200) is grasped (1440) with at least one transfer element (1220, 1223), and the grasp of the collet (1440) on the sheet material of the ornamental bow is released (1442). The collet is withdrawn (1442) from the hub region. The ornamental bow (1200) is translated (1444), by means of the transfer element (1220, 1223), to a finishing station for at least fastening the hub.

In a particular avatar of this method according to an aspect of the invention, between the steps of applying (1408) each trapezoidal sheet to a folding apparatus (1222, 1224) and folding (1412) the movable portion (1224) of the folding apparatus to the folded position, vacuum is applied (1410) to at least some apertures adjacent border portions of-the folding portion (1224) and the fixed portion (1222) of the folding apparatus, to thereby aid in holding the trapezoidal sheet (312) to the folding apparatus (1222, 1224).

In another avatar of this method according to an aspect of the invention, the step of moving (1414) a hold-down bar (1030) includes the step of pressing the juxtaposed border regions onto a plurality of pins (1022N) affixed to the roll-up surface (1022us).

In another avatar of this method according to an aspect of the invention, prior to the step (1430, 1432, 1434) of rotating the collet (1040) and translating the collet (1040), hold-down bar (1030), and element guard (1050), the step is performed of raising (1428) the collet, without raising the hold-down bar (1030) and the element guard.

In another avatar of this method according to an aspect of the invention, in conjunction with the step (1430, 1432, 1434) of simultaneously rotating the collet and translating the collet (1040), hold-down bar (1030), and element guard (1050), of raising the collet (1040) monotonically as a function of position of the collet (1040) relative to the roll-up bar (1022).

What is claimed is:

1. A web cutting apparatus for cutting individual trapezoidal sheets from an end of said web, said apparatus comprising:
a movable carriage movable in a fore-aft direction;
a generally horizontal rotatable bed mounted on said movable carriage, said rotatable bed being rotatable about a vertical axis;
a web cutter affixed to said rotatable bed, said cutter cutting along a cutting path making a fixed angle across said rotatable bed;
a positioning surface extending parallel with said cutting path and affixed to said rotatable bed;
a trapezoidal transfer head defining first and second non-parallel sides, said transfer head being rotatable about a vertical axis, and movable in said fore-aft direction;
a brake connected to said carriage; and
control means coupled to said transfer head and to said web cutter, for sequentially (a) moving said transfer head in said aft direction with a first orientation such as to bring a first of said non-parallel sides into contact with said positioning surface, whereby said positioning surface rotates into parallelism with said first of said non-parallel sides, (b) moving said transfer head in said aft direction against the force of said brake after said positioning surface is parallel with said first non-parallel side of said transfer head, to thereby move said rotatable bed in said aft direction, (c) locking said transfer head to said rotatable bed and to said web, (d) moving said transfer head in said fore direction, carrying said rotatable bed and said web therewith, (e) when said transfer head and rotatable bed have moved in said fore direction by a dimension of one of said trapezoidal sheets, stopping said motion in said fore direction, (f) actuating said web cutter to thereby cut that portion of said web lying under said transfer head from the remaining portion of said web and define a separated trapezoidal sheet, and (g) releasing said transfer head from said rotatable bed, while continuing to lock said transfer head to said separated trapezoidal sheet.

2. A web cutting apparatus according to claim 1, wherein said control means is further for:
moving said transfer head with said separated trapezoidal sheet to a target location; and
depositing said separated trapezoidal sheet at said target location.

3. A web cutting apparatus according to claim 2, wherein said control means is further for: (a) rotating said transfer head around said vertical axis, and moving said transfer head in said aft direction with a second orientation such as to bring a second of said non-parallel sides into contact with said positioning surface, whereby said positioning surface rotates into parallelism with said second of said non-parallel sides, (b) moving said transfer head in said aft direction against the force of said brake after said positioning surface is parallel with said second non-parallel side of said transfer head, to thereby move said rotatable bed in said aft direction, (c) locking said transfer head to said rotatable bed and to said web, (d) moving said transfer head in said fore direction, carrying said rotatable bed and said web therewith, (e) when said transfer head and rotatable bed have moved in said fore direction by a dimension of one of said trapezoidal sheets, stopping said motion in said fore direction, stopping said motion in said fore direction, (f) actuating said web cutter to thereby cut that portion of said web lying under said transfer head from the remaining portion of said web and define a second separated trapezoidal sheet, and (g) releasing said transfer head from said rotatable bed, while continuing to lock said transfer head to said second separated trapezoidal sheet.

4. A web cutting apparatus according to claim 3, wherein said control means is further for:
moving said transfer head with said second separated trapezoidal sheet to said target location; and
depositing said separated trapezoidal sheet at said target location.

5. A web cutting apparatus according to claim 2, wherein said control means is further for:
rotating said transfer head about said vertical axis in conjunction with moving said transfer head with said first separated trapezoidal sheet to said target location.

6. A web cutting apparatus according to claim 1, further including a controllable web brake for controllably braking said web; and wherein
said control means is further for setting said web brake at all times except that time beginning at which said transfer head begins to move in said fore direction locked to said web and ending at the time of cutting.

7. A web cutting apparatus according to claim 1, further comprising a web loop control for tending to maintain a minimum length of hanging loop of web for reducing frictional forces on said web during that time during which said web moves in said fore direction locked to said transfer head.

8. A web cutting and sheet transfer apparatus, comprising:
advancing means for advancing said web material onto a cutting bed;
cutting means for sequentially cutting individual trapezoidal sheets from an end of said web, said cutting means comprising a cutting element mounted below said cutting bed for controllably cutting along a path associated with said cutting head;
cutting bed rotating means coupled to said cutting head, for rotating said cutting bed by a selected amount between cuts, so that cuts at various angles across said web material sequentially create individual trapezoidal sheets, alternately oppositely oriented on said cutting bed;
transfer means associated with said cutting means, said transfer means including a transfer head having the same general shape as said individual trapezoidal sheets and also including means for controllably attaching said individual trapezoidal sheets to said transfer head at least along a border of said individual trapezoidal sheets, for sequentially picking up said individual trapezoidal sheets, and transferring said individual trapezoidal sheets to a location remote from said cutting bed; and
transfer rotation means coupled to said transfer means, for rotating said transfer head so that said individual trapezoidal sheets sequentially transferred to said remote location are placed at said remote location in the same orientation.

9. An apparatus for rolling ornamental objects, from individual sheets of trapezoidal material defining plural border regions, said apparatus comprising:
a fixed roll-up bar defining a flat, straight upper surface;
a movable folding bar defining a generally straight, flat surface, said movable folding bar being rotatable around an axis from a first position to a second position, so as to bring an edge of said movable folding bar into juxtaposition with an edge of said flat, straight surface of said roll-up bar, and so as to not cover said flat, straight surface of said roll-up bar, said movable folding bar further including controllable affixation means adapted for holding at least a portion of one of said border regions of an individual trapezoidal sheet of workpiece material against said movable folding bar;
folding means coupled to said movable folding bar, for rotating said movable folding bar into said juxtaposition with said edge of said flat, straight surface of said roll-up bar, whereby at least a portion of one of said border regions of said individual trapezoidal sheet is juxtaposed with at least a portion of an other one of said border regions of said individual trapezoidal sheet;
temporary affixation means associated with said roll-up bar, for at least temporarily holding together said juxtaposed border regions of said individual trapezoidal sheet;
a grasping collet for grasping said juxtaposed border regions of said individual trapezoidal sheet, said collet being controllably rotatable and translatable from a starting position;
a movable trapezoidal sheet hold-down bar movable with respect to said flat, straight surface of said roll-up bar, said trapezoidal sheet hold-down bar including a straight surface for, when said straight surface of said trapezoidal sheet hold-down bar is juxtaposed with said flat, straight surface of said roll-up bar, tending to hold said juxtaposed border regions of said individual trapezoidal sheet in communication with said affixation means; and
control means for, when a single trapezoidal sheet is placed on said movable folding bar in said first position thereof, performing the steps of (a) causing said folding means to operate to thereby fold said trapezoidal sheet to form a folded trapezoidal sheet, (b) causing said movable trapezoidal sheet hold-down bar to move relative to said flat, straight surface of said roll-up bar to become juxtaposed therewith, for tending to hold said juxtaposed border regions of said individual trapezoidal sheet in communication with said affixation means, (c) causing said collet to grasp said juxtaposed border regions of said individual trapezoidal sheet, (d) causing said collet to rotate in conjunction with translation of at least said collet along a path generally parallel with said flat, straight surface of said roll-up bar, whereby at least said juxtaposed border portions of said individual trapezoidal sheet are wound on said collet to define a hub, (e) stopping said rotation of said collet and said translation, (f) grasping said hub with a transfer apparatus while removing said collet from said hub, and (g) moving said trapezoidal sheet hold-down bar from said juxtaposition, translating said collet to its starting position, and causing said movable folding bar to move to said first position.

10. An apparatus according to claim 9, wherein:
said affixation means comprises a plurality of pins extending orthogonally from said flat, straight surface of said roll-up bar; and
said flat, straight surface of said trapezoidal sheet hold-down bar defines an elongated groove dimensioned to clear said pins when said flat, straight surface of said trapezoidal sheet hold-down bar is juxtaposed with said flat, straight surface of said roll-up bar.

11. An apparatus according to claim 9, wherein said starting position of said collet lies in a cutout in said flat, straight upper surface of said roll-up bar, and said control means causes said collet to translate to a location above said cutout before said step of causing said collet to rotate in conjunction with translation of at least said collet along a path generally parallel with said flat, straight surface of said roll-up bar.

12. An apparatus according to claim 9, wherein said controllable affixation means associated with said movable folding bar comprises a plurality of controlled-vacuum apertures adapted for holding at least a portion of one of said border regions of an individual trapezoidal sheet, and said control means, after said step of causing said movable trapezoidal sheet hold-down bar to move relative to said flat, straight surface of said roll-up bar to become juxtaposed therewith, for tending to hold said juxtaposed border regions of said individual trapezoidal sheet in communication with said affixation means, performs the additional step of turning off the vacuum in said controlled-vacuum apertures.

13. An apparatus according to claim 9, wherein said control means, in conjunction with said step of causing said translation of at least said collet along a path generally parallel with said flat, straight surface of said roll-up bar, further causes the translation of said trapezoidal sheet hold-down bar generally in consonance with said translation of said collet.

14. An apparatus according to claim 9, wherein said fixed roll-up bar defining a flat, straight upper surface further defines a front surface generally orthogonal to said flat, straight upper surface, and said apparatus further comprises:
an element guard hinged along an axis generally orthogonal to said front surface, and movable from a disengaged position to an engaged position lying adjacent to said front surface; and wherein said control means further performs the step, prior to said step of causing said collet to rotate in conjunction with translation of at least said collet along a path generally parallel with said flat, straight surface of said roll-up bar, of moving said element guard to said engaged position.

15. An apparatus according to claim 9, further comprising an element guard, and wherein said control means, in conjunction with said step of causing said translation of at least said collet along a path generally parallel with said flat, straight surface of said roll-up bar, further causes the translation of said element guard generally in consonance with said translation of said collet.

16. A method for making a bow from individual trapezoidal sheets of material by means of a machine, where said sheets of material define at least generally parallel slits extending between border regions to thereby define generally parallel strips, said method comprising the steps of:
applying each said trapezoidal sheet to a folding apparatus including at least a portion of a roll-up surface of a fixed rollup element and a movable folding element which, when folded, is juxtaposed with an edge of said roll-up surface, but which does not fully extend thereover, said applying of each said trapezoidal sheet being in such a manner that a border portion of said trapezoidal sheet extends beyond said folding element, whereby, when said folding portion of said folding apparatus is folded toward said roll-up element, at least a border region of the folded trapezoidal sheet is exposed above said roll-up surface;
folding said movable element of said folding apparatus to a folded position, thereby bringing said borders of said trapezoidal sheet into juxtaposition over said roll-up surface of said roll-up element, and forming said strips into loops;
moving a hold-down bar toward said roll-up surface of said roll-up element, to thereby press together said juxtaposed border regions of said folded trapezoidal sheet;
translating an element guard in a first direction generally parallel with a front surface of said roll-up element, to a position in which portions of said loops of said trapezoidal sheet remote from said hold-down bar extend generally parallel with said front surface of said roll-up element;
grasping, with a rotatable collet, said juxtaposed border regions at a location near a first end of said folded trapezoidal sheet;
simultaneously rotating said collet and translating said collet, hold-down bar, and element guard toward a second end of said trapezoidal sheet, opposite to said first end, to thereby form said ornamental bow, said ornamental bow having a hub wound about said collet;
translating said element guard in a second direction opposite to said first direction;
grasping said hub of said ornamental bow with at least one transfer element;
releasing said grasp of said collet on said sheet material of said ornamental bow, and withdrawing said collet from said hub region; and
translating said ornamental bow, by means of said transfer element, to a finishing station for at least fastening said hub.

17. A method according to claim 16, wherein, between said steps of applying each said trapezoidal sheet to a folding apparatus and folding said movable portion of said folding apparatus to said folded position, vacuum is applied to at least some apertures adjacent border portions of said folding portion and said fixed portion of said folding apparatus, to thereby aid in holding said trapezoidal sheet to said folding apparatus.

18. A method according to claim 16, wherein said step of moving a hold-down bar includes the step of pressing said juxtaposed border regions onto a plurality of pins affixed to said roll-up surface.

19. A method according to claim 16, further comprising, prior to said step of rotating said collet and translating said collet, hold-down bar, and element guard, raising said collet, without raising said hold-down bar and said element guard.

20. A method according to claim 16, further including the step, in conjunction with said step of
simultaneously rotating said collet and translating said collet, hold-down bar, and element guard, of raising said collet monotonically as a function of position of said collet relative to said roll-up bar.
